(19) United States
(12) Patent Application Publication
(10) Pub. No.: US 2024/0396182 A1
(43) Pub. Date: Nov. 28, 2024

(54) ANODE TAB EXTENSIONS, AND ASSOCIATED ARTICLES AND METHODS

(71) Applicant: Sion Power Corporation, Tucson, AZ (US)

(72) Inventors: Shane Harrel, Tucson, AZ (US); Alex Khakhalev, Ann Arbor, MI (US); Alexandra Spotts, Tucson, AZ (US)

(73) Assignee: Sion Power Corporation, Tucson, AZ (US)

(21) Appl. No.: 18/417,525

(22) Filed: Jan. 19, 2024

Related U.S. Application Data
(60) Provisional application No. 63/440,216, filed on Jan. 20, 2023.

(51) Int. Cl. H01M 50/536; H01M 4/02; H01M 4/04; H01M 4/1395; H01M 4/38; H01M 50/533

(52) U.S. Cl. CPC H01M 50/536; H01M 4/0421; H01M 4/1395; H01M 4/382; H01M 50/533; H01M 2004/027; H01M 2220/20

(57) ABSTRACT

Anode tab extensions, and associated articles and methods are generally described. Methods for electrically coupling anode portions within electrochemical devices, and associated articles and systems, are generally described. In some cases, an electrically non-conductive layer is disposed between multiple anode portions that are to be coupled. In some cases, the method comprises welding metal extension tabs to the multiple anodes to establish electrical connection between the multiple anodes that are separated by one or more electrically non-conductive layers and the anode terminal.

### RELATED APPLICATIONS

This application claims priority to U.S. Provisional Application No. 63/440,216, filed Jan. 20, 2023, which is incorporated herein by reference in its entirety.

### TECHNICAL FIELD

Anode tab extensions, and associated articles and methods are generally described.

### BACKGROUND

Electrochemical cells typically include electrodes comprising electrode active materials that participate in an electrochemical reaction to produce electric current. A typical electrochemical device, such as a battery, includes terminals that can be used for electrically coupling the electrodes of the electrochemical device to external circuitry. Some embodiments of the present disclosure are directed to inventive methods, systems, and articles for coupling electrodes of electrochemical cells.

### SUMMARY

The present disclosure is related to anode tab extensions, and associated articles and methods. The subject matter of the present invention involves, in some cases, interrelated products, alternative solutions to a particular problem, and/or a plurality of different uses of one or more systems and/or articles.

In some aspects, anode structures are provided.

In some embodiments, the anode structure comprises a first anode current collector; a first anode electroactive material layer comprising a lithium film deposited on a first side of the first anode current collector; a first electrically non-conductive layer positioned adjacent a second side of the first anode current collector opposite the first side; and a first anode extension tab positioned adjacent the first anode electroactive material layer at a side opposite the first anode current collector; and a first weld formed through a portion of the first anode electroactive material layer between at least a portion of the first anode extension tab and at a least a portion of the first anode current collector.

In some embodiments, the anode structure comprises an electrically non-conductive layer comprising a first side and a second side; a first anode current collector positioned adjacent the first side of the electrically non-conductive layer; a second anode current collector positioned adjacent the second side of the electrically non-conductive layer; a first anode electroactive material layer comprising a lithium film positioned adjacent the first anode current collector at a side opposite the electrically non-conductive layer; a second anode electroactive material layer comprising a lithium film positioned adjacent the second anode current collector at a side opposite the electrically non-conductive layer; a first anode extension tab welded through the first anode electroactive material layer to the first anode current collector; and a second anode extension tab welded through the second anode electroactive material layer to the second anode current collector.

In some aspects, a method is provided.

In some embodiments, the method comprises in an anode structure comprising: a first anode current collector; and a first anode electroactive material layer comprising a lithium film deposited on a first side of the first anode current collector, performing the steps of: welding at least a portion of a first anode extension tab to a portion of the anode structure, such that a first weld protrudes through at least a portion of the first anode electroactive material layer and connects to at least a portion of the first anode current collector.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is an exemplary schematic illustration depicting a cross-sectional view of a single-sided anode structure, according to some embodiments;

FIG. 1B is an exemplary schematic illustration depicting a top view of a weld, according to some embodiments;

FIG. 2A is an exemplary schematic illustration depicting a cross-sectional view of a double-sided anode structure, according to some embodiments;

FIG. 2B is an exemplary schematic illustration depicting a top-down view of a doubled-sided anode structure, according to some embodiments;

FIG. 3A is an exemplary schematic illustration depicting top-down (upper) and cross-sectional (lower) views of various electrochemical components in an electrochemical device, according to some embodiments;

FIG. 3B is an exemplary schematic illustration depicting a top view of an electrochemical device, according to some embodiments;

FIG. 4A is an exemplary schematic illustration depicting a top view of an electrochemical device comprising a plurality of anode structures, according to some embodiments;

FIG. 4B is an exemplary schematic illustration depicting a top-down view of the electrochemical device shown in FIG. 4A, according to some embodiments;

FIG. 4C is an exemplary schematic illustration depicting a perspective view of the electrochemical device shown in FIG. 4A, according to some embodiments;

FIG. 4D is an exemplary schematic illustration depicting a top view of an anode portion of the electrochemical device shown in FIG. 4A, according to some embodiments;

FIG. 4E is an exemplary schematic illustration depicting a perspective view of an anode portion of the electrochemical device shown in FIG. 4A, according to some embodiments;

FIG. 5A is an exemplary schematic illustration of a cross-sectional view of a stack of anode portions of the electrochemical device of FIGS. 4A-4E, according to some embodiments;

FIG. 5B is an exemplary schematic illustration of a cross-sectional view of a portion of the anode portion shown in FIG. 5A, according to some embodiments;

FIG. 5C is an exemplary schematic illustration of a cross-sectional view of a cathode portion of the electrochemical device of FIGS. 4A-4E, according to some embodiments;

FIG. 6 is an exemplary schematic illustration of a cross-sectional view of an electric vehicle comprising an electrochemical device, according to some embodiments;

FIGS. 7A-7B are photographs of a double-sided anode structure, according to some embodiments; and

FIG. 8 is a photograph of an electrochemical cell comprising double-sided anode structures, according to some embodiments.

### DETAILED DESCRIPTION

Anode tab extensions, and associated articles and methods, are generally described. Some methods comprise forming welds between various electrode portions (e.g., anode portions) in order to electrically couple multiple electrode portions within an electrochemical device that are separated by one or more electrically non-conductive layers, such that an electrical connection between the multiple electrode portions and an electrically conductive terminal may be achieved. As a non-limiting example, in some cases, an anode terminal of a battery pack is coupled to multiple anode portions (e.g., vapor-deposited lithium layers) from that battery stack via a plurality of anode extensions tabs (e.g., metal extension tabs). Despite electrically non-conductive layer(s) (e.g., release layer(s)) being interposed between those anode portions, the anode portions may have good electrical contact with the anode terminal, at least in part due to the welds formed between the anode extension tabs and the multiple anode portions.

Some aspects of the present disclosure are directed to the discovery that the use of anode extension tabs (e.g., copper extension tabs) may provide a weldable interface to the anode terminal, such that multiple anode structures may be welded to the anode terminal via the anode extension tabs to form a multilayered anode structure. For example, individual anode extension tabs may be welded to each of the multiple anode portions and the stack of anode extension tabs may then be together welded to an electrochemical cell tab to established connection with an electrically conductive terminal.

Establishing efficient charge transport between electrodes and a terminal of an electrochemical device can be important for the performance of that electrochemical device during cycling. However, some electrode configurations may pose difficulties for transporting charge from portions of the electrodes to the terminal. For example, in some cases, when electrically non-conductive layers separate electrode portions, transporting charge from one electrode portion to another electrode portion may be difficult due to a lack of a facile electrically conductive pathway, thereby creating high resistances between the terminal of the electrochemical device and the electrodes (e.g., anodes). As one non-limiting example, some electrochemical devices may employ stacks of “sandwich”-type double-sided electrodes such as anodes comprising two vapor-deposited lithium layers separated by an electrically non-conductive layer (e.g., a release layer). The presence of the electrically non-conductive layer can limit the ability for current to flow from one anode to the other anode in the sandwich electrode and make it difficult to collect current from any anodes not in direct contact with the terminal. While one could attempt to remove the electrically non-conductive layers of the electrodes, such a process can be difficult and expensive. Additionally, while one could employ a crimping process to penetrate both sides of the anode structure to establish electrical coupling between the two vapor-deposited lithium layers, such a process may oftentimes lead to a variety of problems, such as a reduction in the overall structural integrity (e.g., smearing of the vapor-deposited lithium layers) and mechanical strength (e.g., tensile strength) of the anode structure. As such, simple and non-destructive processes for establishing electrical communication between electrodes separated by electrically non-conductive layers would be desirable. The methods described herein, in some cases, provide for such processes.

It has been discovered within the context of this disclosure that welding anode extension tabs to individual anode portions can establish efficient electrical coupling between the anode portions and with the electrically conductive terminal, without damaging the structural integrity and strength of the anode portions. The methods and articles (e.g., articles comprising anode extension tabs) described herein may, in some but not necessarily all cases, avoid the need for removing electrically non-conductive layers and/or the need for crimping, thereby increasing manufacturing efficiency and minimizing damage to the integrity of the anodes while still maintaining suitable performance of the electrochemical device. Additionally, some embodiments are related to the discovery that the welding process can provide one or more of a variety of operational advantages, such as allowing for joining of thin metal materials with thin, low-defect welds having relatively low electrical resistance and high mechanical strength, preserving mechanical integrity and strength of individual anode portions, and leading to improved electrical and mechanical connection between the individual anode portions and the electrically conductive terminal.

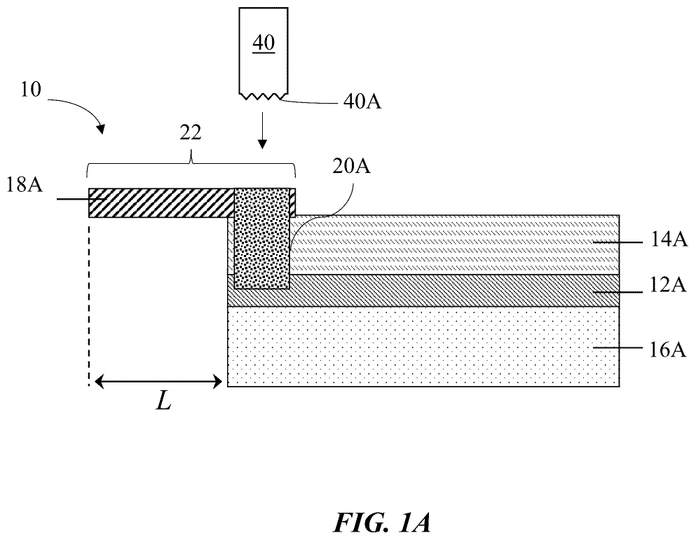

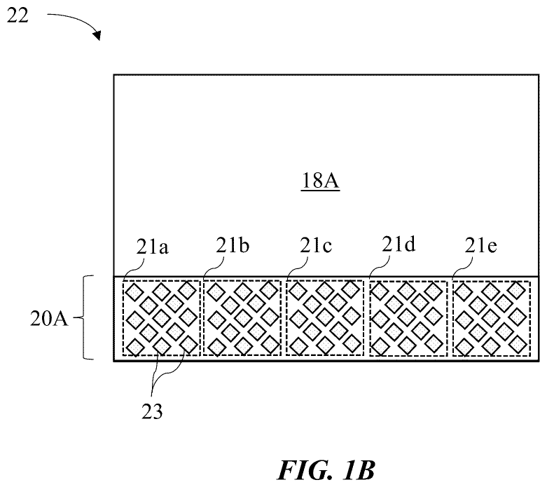

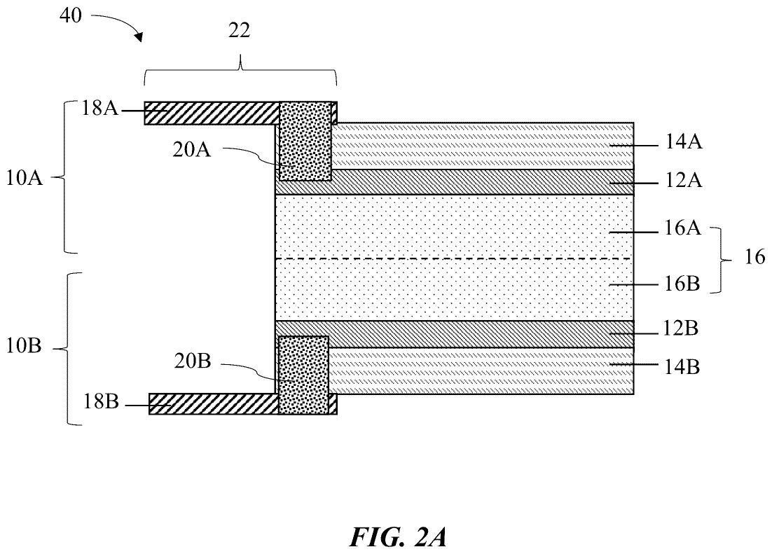

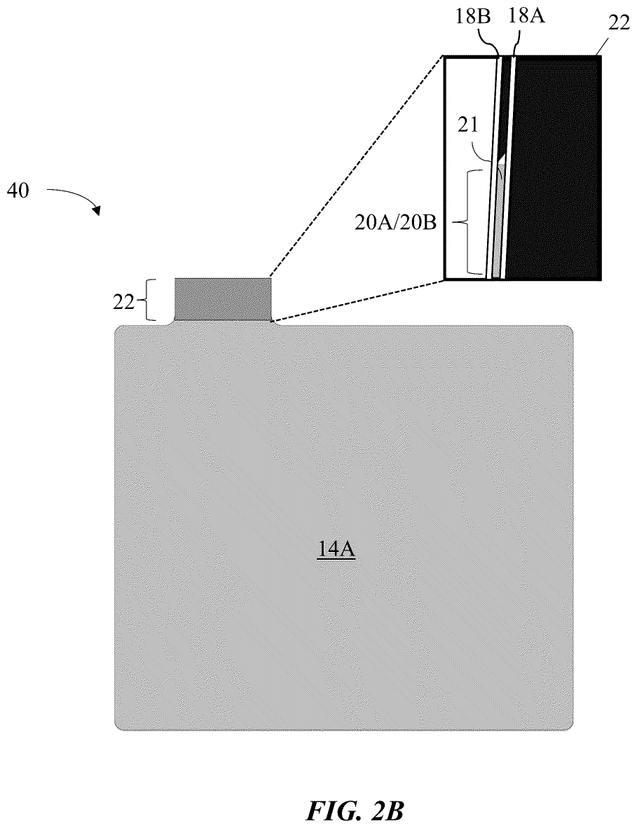

In some aspects, an electrode structure is provided. In some cases, the electrode structure is an anode structure. The anode structure, according to some embodiments, may be either a single-sided anode structure or a double-sided anode structure. A single-sided anode structure, according to some embodiments, may refer to an anode structure comprising a single layer of anode electroactive material layer. A double-sided anode structure, according to some embodiments, may refer to an anode structure comprising two anode electroactive material layers separated by one or more electrically non-conductive layers (e.g., release layer(s)). A non-limiting example of a single-sided anode structure (e.g., anode structure 10) is shown in FIG. 1A and a non-limiting example of a double-sided anode structure (e.g., anode structure 40) is shown in FIGS. 2A-2B. These figures are referred to throughout the disclosure below. As described in more detail below, the anode structure may comprise various components, including, but not limited to, anode current collector(s), anode electroactive material layer(s), anode metal extension tab(s), optional protective layers, optional electrically non-conductive layer(s) (e.g., insulation layer(s), release layer(s)), etc.

In some embodiments, the anode structure comprises at least one anode current collector. In one set of embodiments, the anode structure comprises a first anode current collector. For example, as shown in FIG. 1A, an anode structure 10 (e.g., a single-sided anode structure) may comprise a first anode current collector 12A. In some embodiments, the anode structure further comprises at least one anode electroactive material layer comprising a lithium film (e.g., lithium metal and/or a lithium metal alloy). For example, the anode structure, according to some embodiments, may comprise a first anode electroactive material layer comprising a lithium film deposited on a first side of the first anode current collector. Referring again to FIG. 1A, the anode structure 10 may further comprise a first anode electroactive material layer 14A comprising a lithium film deposited on a first side of the first anode current collector 12A. As described in more details below, the anode electroactive material layer, according to some embodiments, comprises a vapor-deposited lithium (e.g., VDLi) film.

In some embodiments, the anode structure further comprises at least one electrically non-conductive layer (e.g., a release layer) positioned adjacent (e.g., directly adjacent) the anode current collector. In one set of embodiments, the anode structure comprises a first electrically non-conductive layer positioned adjacent a second side of the first anode current collector opposite the first side of the first current collector. For example, as shown in FIG. 1A, the anode structure 10 further comprises a first electrically non-conductive layer 16A positioned adjacent a second side of the first anode current collector 12A opposite the first side of the first current collector 12A.

As used herein, when a layer is referred to as being “on”, “on top of”, or “adjacent” another layer, it can be directly on, on top of, or adjacent the layer, or an intervening layer may also be present. A layer that is “directly on”, “directly adjacent” or “in contact with” another layer means that no intervening layer is present. Likewise, a layer that is positioned “between” two layers may be directly between the two layers such that no intervening layer is present, or an intervening layer may be present.

In some embodiments, the anode structure further comprises an anode extension portion that is an extension of the anode structure. For example, as shown in FIG. 1A, the anode structure comprises an anode extension portion 22. In some embodiments, the anode extension portion comprises at least one anode extension tab (e.g., a metal extension tab) positioned adjacent the anode electroactive material layer, e.g., at a side opposite the anode current collector. For instance, in one set of embodiments, the anode structure comprises a first anode extension tab (e.g., a metal extension tab) positioned adjacent the first anode electroactive material layer at a side opposite the first anode current collector. For example, referring to FIG. 1A, the anode structure 10 may further comprise a first metal extension tab 18A positioned adjacent the first anode electroactive material layer 14A at a side opposite the first anode current collector 12A. The anode extension tab may comprise any of a variety of metals and/or a metal alloys described elsewhere herein.

In some embodiments, the anode structure further comprises at least one weld electrically coupling the anode extension tab to the anode current collector. According to some embodiments, the weld may be formed through (e.g., across a thickness of) at least a portion of the anode electroactive material layer between at least a portion of the anode extension tab and at a least a portion of the anode current collector. For example, in one set of embodiments, a first weld may be formed through (e.g., across a thickness of) at least a portion of the first anode electroactive material layer between at least a portion of the first anode extension tab and at a least a portion of the first anode current collector. For example, as shown in FIG. 1A, the anode structure 10 may further comprise a first weld 20A formed through (e.g., across a thickness of) a portion of the first anode electroactive material layer 14A between a portion of the first anode extension tab 18A and a portion of the first anode current collector 12A. For example, the weld may be formed through an end portion (e.g., edge portion) of the anode electroactive material layer between a corresponding end portion of the anode extension tab and a corresponding end portion of the anode current collector. The weld, according to some embodiments, is configured to bond (e.g., fuse) the end portions of the various layers, e.g., the anode extension tab, the anode electroactive material layer, and the anode current collector, such that the anode extension tab becomes electrically coupled to the anode current collector. The weld may have any appropriate dimensions and/or properties described elsewhere herein. Any of a variety of appropriate welding methods may be employed to form the weld described herein. For example, during welding, the various materials within the anode extension tab, the anode electroactive material layer, and/or the anode current collector may melt and subsequently fuse together to form the weld. A top view of a weld is shown in FIG. 1B and is described in more detail below.

In some embodiments, the anode structure further comprises a substrate positioned adjacent the electrically non-conductive layer at a side opposite the anode current collector. For example, as shown in FIG. 1A, the anode structure 10 may further comprise a substrate (not shown) positioned adjacent the first electrically non-conductive layer 16A at a side opposite the first anode current collector 12A. The substrate, according to some embodiments, may be electrically non-conductive. The substrate may be used as a solid surface upon which some components of the article and/or electrochemical device are formed during fabrication, but not necessarily included in the finished article or electrochemical device), according to some embodiments. As described in more detail below, the substrate may be removed or released from the electrically non-conductive layer (e.g., the release layer) prior to being assembled into an electrochemical cell, according to some embodiments.

While FIG. 1A shows a set of embodiments in which the anode structure is a single-sided anode structure comprising a single anode electroactive material layer, it should be understood that not all embodiments described herein are so limited, and in other embodiments, the anode structure is a double-sided anode structure (having a “sandwiched” configuration) comprising two anode electroactive material layers (e.g., VDLi layers). For example, FIGS. 2A-2B can be used to illustrate one such embodiment of a double-sided anode structure. In one set of embodiments, the double-sided anode structure may be formed from two (e.g., two identical or two different) single-sided anode structures. For example, as shown in FIG. 2A, the anode structure 40 (e.g., a double-sided anode structure) may be formed from two single-sided anode structures (e.g., anode structure 10) joined via their respective electrically non-conductive layers (e.g., first electrically non-conductive layer 16A and second electrically non-conductive layer 16B).

In some embodiments in which the anode structure is a double-sided anode structure, the anode structure further comprises a second electrically non-conductive layer positioned adjacent the first electrically non-conductive layer at a side opposite the first anode current collector. For example, as shown in FIG. 2A, the anode structure 40 further comprises a second electrically non-conductive layer 16B positioned adjacent the first electrically non-conductive layer 16A at a side opposite the first anode current collector 12A. The first and the second electrically non-conductive layers 16A and 16B, according to some embodiments, may be the same or different, and may comprise any of a variety of appropriate materials described elsewhere herein.

In some embodiments, the anode structure (e.g., a double-sided anode structure) further comprises a second current collector positioned adjacent the second electrically non-conductive layer at a side opposite the first electrically non-conductive layer. For example, referring again to FIG. 2A, the anode structure 40 further comprises a second current collector 12B positioned adjacent the second electrically non-conductive layer 16B at a side opposite first electrically non-conductive layer 16A. The first and the second anode current collectors 12A and 12B, according to some embodiments, may be the same or different, and may comprise any of a variety of materials described elsewhere herein.

The anode structure (e.g., a double-sided anode structure), in some embodiments, further comprises a second anode electroactive material layer comprising a lithium film deposited on the second anode current collector at a side opposite the second electrically non-conductive layer. For example, as shown in FIG. 2A, the anode structure 40 may further comprise a second anode electroactive material layer 14B comprising a lithium film deposited on the second anode current collector 12B at a side opposite the second electrically non-conductive layer 16B. The first and the second anode electroactive material layers 14A and 14B, according to some embodiments, may be the same or different, and may comprise any of a variety of materials described elsewhere herein.

In some embodiments in which the anode structure is a double-sided anode structure, the anode structure further comprises a second anode extension tab (e.g., a metal extension tab) positioned adjacent the second anode electroactive material layer at a side opposite the second anode current collector. For example, as shown in FIG. 2A, the anode structure 40 may further comprise a second anode extension tab 18B positioned adjacent the second anode electroactive material layer 14B at a side opposite the second anode current collector 12B. The first and the second anode extension tabs 18A and 18B, in some embodiments, may be the same or different, and may comprise any of a variety of materials described elsewhere herein.

According to some embodiments, the anode structure (e.g., a double-sided anode structure) further comprises a second weld formed through a portion of the second anode electroactive material layer (e.g., a VDLi layer) between at least a portion of the second anode extension tab and at a least a portion of the second anode current collector. For example, as shown in FIG. 2A, the anode structure 40 further comprises a second weld 20B formed through a portion (e.g., an end portion) of the second anode electroactive material layer 14B between at least a portion (e.g., an end portion) of the second anode extension tab 18B and at least a portion (e.g., an end portion) of the second anode current collector 12B. The first and the second welds 20A and 20B, in some embodiments, may be the same or different, and may comprise any of a variety of materials described elsewhere herein.

While FIG. 2A shows a set of embodiments in which the anode structure comprises two separate electrically non-conductive layers joined together, it should be understood that not all embodiments described herein are so limited, and in other embodiments, the anode structure may comprise a single electrically non-conductive layer. For example, referring to FIG. 2A as a non-limiting example, the anode structure (e.g., anode structure 40) may instead comprise a single electrically non-conductive layer (e.g., electrically non-conductive layer 16) comprising a first side and a second side. According to some embodiments, a first anode current collector (e.g., first anode current collector 12A) may be positioned adjacent the first side of the electrically non-conductive layer (e.g., electrically non-conductive layer 16), and a second anode current collector (e.g., second anode current collector 12B) may be positioned adjacent the second side of the electrically non-conductive layer (e.g., electrically non-conductive layer 16). A first anode electroactive material layer (e.g., first anode electroactive material layer 14A) comprising a lithium film may be positioned adjacent the first anode current collector (e.g., first anode current collector 12A) at a side opposite the electrically non-conductive layer (e.g., electrically non-conductive layer 16), and a second anode electroactive material layer (e.g., second anode electroactive material layer 14B) comprising a lithium film may be positioned adjacent the second anode current collector (e.g., second anode current collector 12B) at a side opposite the electrically non-conductive layer (e.g., electrically non-conductive layer 16).

According to some embodiments, the anode structure further comprises a first weld (e.g., first weld 20A) formed through a portion of the first anode electroactive material layer (e.g., first anode electroactive material layer 14A) between at least a portion of the first anode extension tab (e.g., first anode extension tab 18A) and at a least a portion of the first anode current collector (e.g., first anode current collector 12A). Similarly, a second weld (e.g., second weld 20B) may be formed through a portion of the second anode electroactive material layer (e.g., second anode electroactive material layer 14B) between at least a portion of the second anode extension tab (e.g., second anode extension tab 18B) and at a least a portion of the second anode current collector (e.g., second anode current collector 12B). According to some embodiments, the first weld may be formed at an end portion (e.g., an edge) of the first anode current collector and the first anode electroactive material layer, and the second weld may be formed at an end portion (e.g., an edge) of the second anode current collector and the second anode electroactive material layer.

FIG. 2B is an exemplary schematic illustration depicting a top-down view of the doubled-sided anode structure shown in FIG. 2A, according to some embodiments. As shown, anode structure 40 comprises an anode extension portion 22 that is an extension of the anode structure. The anode extension portion 22 comprises two anode extension tabs 18A and 18B welded to end portions of the intervening layers 21 positioned between the anode extension tabs. The intervening layers 21 may include the various layers shown in FIG. 2A, such as the electrically non-conductive layer(s) (e.g., layers 16, 16A and/or 16B), the anode current collectors (e.g., layers 12A and 12B), and the anode electroactive material layers (e.g., layers 14A and 14B), arranged in the configuration shown in FIG. 2A. As shown, one or more welds (e.g., weld 20A and 20B) may be formed between the anode extension tabs and the intervening layers.

A double-sided anode structure as shown in FIGS. 2A-2B for use in an electrochemical device may have one or more advantages. Such a double-sided anode structure—comprising an electrically non-conductive layer 16 (which, itself, can comprise two layers 16A and 16B, or may be a single layer) with a first side and a second side, a first anode portion (comprising a first anode electroactive material layer deposited on a first anode current collector) adjacent to the first side, and a second anode portion adjacent (comprising a second anode electroactive material layer deposited on a first anode current collector) to the second side—may provide for a high energy density electrode in electrochemical devices such as batteries. Due to the presence of the electrically non-conductive layer (e.g., release layer) between the first anode portion and the second anode portion, methods described herein may be useful for establishing electrical coupling between the first anode portion and the second anode portion, which can reduce resistance when collecting current from or injecting current into electrochemical devices comprising such double-sided anode structures (e.g., during discharging and/or charging of an electrochemical device). As mentioned above, methods described herein (e.g., involving joining the anode extension tabs to an electrochemical cell tab) may result in an article in which multiple anodes that are electrically coupled to an electrochemical cell tab via the multiple anode extension tabs extending from the anodes.

While FIGS. 1A-2B describe various embodiments of an anode structure, it should be understood that the disclosure is not so limited, and in some embodiments, a cathode structure may also have one or more configurations described with respect to the anode structures shown FIGS. 1A-2B. For example, the various figures may be employed to describe cathode structures (e.g., single-sided cathode structure 10, double-sided cathode structure 40) comprising the following components: first and/or second cathode current collectors (e.g., layers 12A and/or 12B), first and/or second cathode electroactive material layers (e.g., layers 14A and/or 14B), first and/or second electrically non-conductive layers (e.g., layers 16A and/or 16B), first and/or second cathode extension tabs (e.g., tabs 18A/18B), and first and/or second welds (e.g., weld 20A and/or 20B).

In some aspects, a method for forming an electrode structure (e.g., an anode structure) is provided. The anode structure, according to some embodiments, may have any appropriate configuration described above, such as the single-sided anode structure 10 as shown in FIG. 1A or a double-sided anode structure 40 as shown in FIGS. 2A-2C.

In some embodiments, the method comprises depositing an electroactive material layer comprising lithium film on a first side of the anode current collector. According to some embodiments, the lithium film is vapor deposited onto the first side of the anode current collector. For example, as shown in FIG. 1A, the anode structure 10 may comprise the first anode current collector 12A, and the first anode electroactive material layer 14A comprising lithium film may be deposited (e.g., vapor deposited) on a first side of the first anode current collector 12A.

In some embodiments, the method comprises welding at least a portion (e.g., a portion in contact with the anode electroactive material layer) of an anode extension tab (e.g., a first and/or second anode extension tab) to a portion of the anode structure. For example, the anode extension tab may be welded to an end portion of various layers, e.g., the anode electroactive material layer and/or the anode current collector. For example, as shown in FIG. 1A, at least a portion of the first anode extension tab 18A may be welded to a portion (e.g., an end portion) of the anode structure, such as the end portions of the first electroactive material layer 14A and the anode current collector 12A. The weld is formed through (e.g., protrudes through) at least a portion (e.g., an end portion) of the first anode electroactive material layer and connects (e.g., electrically couples) to at least a portion of the first anode current collector. For example, as shown in FIG. 1A, the first weld 20A is formed through (e.g., protrudes through) an end portion of the first anode electroactive material layer 14A and connects to a corresponding end portion of the first anode current collector 12A.

Any of a variety of appropriate methods of welding may be employed to form the welds described herein. Non-limiting examples of various welding methods include ultrasonic welding, spot welding (e.g., resistance welding), laser welding, vibration welding, hot-plate welding, and/or infrared radiation (IR) welding. Welds produced by some of the methods described herein may offer one or more advantages over some existing methods of joining metal materials. In some aspects, methods of welding that reduce electronic resistance between metal materials are provided. In some aspects, methods of welding that produce a relatively thin weld are provided. The methods disclosed herein can, in some instances, be used to prepare area welds without adversely cutting, cracking, or pitting the metal materials.

As an illustrative example, ultrasonic welding may be employed to form the one or more weld(s). During ultrasonic welding, high-frequency ultrasonic acoustic vibrations are locally applied to the anode structure (which is being held together under pressure) to create a solid-state weld, according to some embodiments. For example, to form the weld, an ultrasonic probe (e.g., a horn or a sonotrode tip) may be first brought in contact with a first region (e.g., a first weld-spot) of the anode extension tab deposited above the various layers (e.g., the anode electroactive material layer, the current collector layer, etc.). The term “weld-spot” is used herein according to its ordinary meaning, and refers to the area over which the ultrasonic vibrations from the probe interacts with the anode extension tab. High-frequency ultrasonic acoustic vibrations may be then applied to the surface of the anode extension tab while the anode structure is being held together under pressure (e.g., a weld head pressure), according to some embodiments. With application of ultrasonic acoustic vibrations, frictional heat is generated and causes the various materials (e.g., portions of the anode extension tab, anode electroactive material layer, and/or anode current collector) to melt and flow. According to some embodiments, as the molten materials begin to cool and solidify, the materials fuse together to form a weld. Accordingly, the weld may be formed through (e.g., protrudes through) the end portion of the anode electroactive material layer and connects to the anode current collector underneath the anode electroactive material layer. The ultrasonic probe may be continuously moved across from one weld-spot of the anode extension tab to another weld-spot (following any appropriate weld path) to weld the various layers together, according to some embodiments. The ultrasonic welding process, compared to other types of welding processes, may advantageously generate less localized heat during use, require relatively low electrical load, and may form a weld having a relatively high mechanical strength, low electrical resistance, and the ability to handle capacity of the associated anode.

FIG. 1A can be used to illustrate a non-limiting embodiment of ultrasonic welding. For example, as shown in FIG. 1A, the first weld 20A may be formed by an application of a high-frequency ultrasonic acoustic vibration to the corresponding end portions of the first anode extension tab 18A, the first anode electroactive material layer 14A, and the first anode current collector 12A, while the various layers are being held together under pressure. To form the weld, an ultrasonic probe 40 may be first used to apply high-frequency ultrasonic acoustic vibrations to an external surface of the first anode extension tab 18A deposited on the end portion of the first anode electroactive material layer 14A. With application of the ultrasonic acoustic vibrations, frictional heat may be generated and cause the various materials (e.g., portions of the first anode extension tab 18A, the anode electroactive material layer 14A, the anode current collector 12A) to melt and flow, according to some embodiments. Accordingly, the various materials may fuse and a first weld 20A may be formed through (e.g., protrudes through) the end portion of the first anode electroactive material layer 14A and connects to the first anode current collector 12A. To form the first weld 20A, the ultrasonic probe 40 may be moved across the surface of the first anode extension tab 18A from one weld-spot to another weld-spot, following any suitable weld path.

In embodiments in which ultrasonic welding is employed, any of a variety of suitable ultrasonic energy, amplitude, and/or welding head pressure may be employed. In some embodiments, an ultrasonic energy of greater than or equal to 0.1 Joules, greater than or equal to 0.2 Joules, greater than or equal to 0.5 Joules, greater than or equal to 1 Joule, greater than or equal to 1.5 Joules, greater than or equal to 2 Joules, greater than or equal to 3 Joules, greater than or equal to 4 Joules, greater than or equal to 6 Joules, greater than or equal to 8 Joules, or more, and/or less than or equal to 10 Joules, less than or equal to 8 Joules, less than or equal to 6 Joules, less than or equal to 4 Joules, less than or equal to 3 Joules, less than or equal to 2 Joules, less than or equal to 1.5 Joules, less than or equal to 1 Joule, less than or equal to 0.5 Joules, less than or equal to 0.2 Joules, or less, may be employed. Combinations of the above-referenced ranges are possible (e.g., greater than or equal to 0.1 Joules and less than or equal to 10 Joules, greater than or equal to 0.1 Joules and less than or equal to 4 Joules, or greater than or equal to 0.1 Joules and less than or equal to 2 Joules) may be employed. Other ranges are also possible.

In some embodiments, an ultrasonic amplitude of greater than or equal to 0.1 microns, greater than or equal to 0.2 microns, greater than or equal to 0.5 microns, greater than or equal to 1 micron, greater than or equal to 2 microns, greater than or equal to 4 microns, greater than or equal to 5 microns, greater than or equal to 7 microns, greater than or equal to 9 microns, or more, and/or less than or equal to 15 microns, less than or equal to 10 microns, less than or equal to 9 microns, greater than or equal to 7 microns, less than or equal to 5 microns, less than or equal to 4 microns, less than or equal to 2 microns, less than or equal to 1 micron, less than or equal to 0.5 microns, less than or equal to 0.2 microns, or less, may be employed. Combination of the above-referenced ranges are possible (e.g., greater than or equal to 0.1 microns and less than or equal to 10 microns, or greater than or equal to 0.1 microns and less than or equal to 5 microns). Other ranges are also possible.

In some embodiments, an ultrasonic welding head pressure of greater than or equal to 1 psi, greater than or equal to 2.5 psi, greater than or equal to 5 psi, greater than or equal to 10 psi, greater than or equal to 15 psi, greater than or equal to 20 psi, greater than or equal to 25 psi, greater than or equal to 30 psi, greater than or equal to 40 psi, or more, and/or less than or equal to 50 psi, less than or equal to 40 psi, less than or equal to 30 psi, less than or equal to 25 psi, less than or equal to 20 psi, less than or equal to 15 psi, less than or equal to 10 psi, less than or equal to 5 psi, less than or equal to 2.5 psi, or less, may be employed. Combinations of the above-referenced ranges are possible (e.g., greater than or equal 1 psi and less than or equal to 50 psi may be employed, or greater than or equal to 5 psi and less than or equal to 25 psi). Other ranges are also possible.

FIG. 1B is a schematic representation showing a non-limiting embodiment of a weld formed using ultrasonic welding. As shown in FIG. 1B, the anode extension portion 22 shown in FIG. 1A comprises the first anode extension tab 18A and the first weld 20A formed between a portion of the first anode extension tab 18A and various layers below the first anode extension tab, such as the first anode electroactive material layer (not shown) and the first anode current collector (not shown). As shown, the first weld 20A may comprise a plurality of weld spots 21a-21e (regions where the probe contacted the anode extension tab). During operation, the ultrasonic probe may first contact the first anode extension tab 18A at weld spot 21a, then moves to weld spot 21b, 21c, 21d, and 21e, respectively. According to some embodiments, a weld may comprise a plurality of weld areas or dots arranged in any suitable order. As shown in FIG. 1B, weld 20A comprises a plurality of weld areas or dots 23 arranged in a particular order. The arrangement of weld areas may depend on the specific geometry of the ultrasonic probe. According to some embodiments, the ultrasonic probe (e.g., probe 40 shown in FIG. 1A) employed to form the weld may have a patterned tip or horn (e.g., tip 40A shown in FIG. 1A) having a specific set of patterns and/or protrusions. Ultrasonic vibrations may be emitted from the patterned tip to form the patterned weld areas 23 shown in FIG. 1B, according to some embodiments. The plurality of weld areas or dots may be present in any appropriate number (e.g., number per unit surface area) and may have any suitable dimension (e.g., surface area) and/or shape.

In some embodiments, the method further comprises forming a double-sided anode structure (e.g., anode structure 40 as shown in FIGS. 2A-2B). In some embodiments, the double-sided anode structure may be formed by joining two (identical) single-sided anode structures, such that the two anode structures are joined together via their respective electrically non-conductive layers. For example, as shown in FIGS. 2A-2B, the anode structure 40 may be formed by joining two (identical) single-sided anode structures (e.g., anode structure 10 shown in FIG. 1A), such that the two anode structures are joined together via their respective electrically non-conductive layers (e.g., first and second electrically non-conductive layer 16A and 16B), with the two anode electroactive material layers facing away from each other. The two single-sided anode structures may be joined using any appropriate methods, such as by lamination. In embodiments in which the single-sided anode structures (e.g., anode structure 10 shown in FIG. 1A) comprise a substrate positioned adjacent the electrically non-conductive layer (e.g., the release layer), the substrate may be removed prior to joining the respective electrically non-conductive layers of two identical single-sided anode structures together.

In some aspects, electrochemical devices and components are provided. In some embodiments, the electrochemical devices and components comprise a first electrode (e.g., an anode structure described herein), a second electrode (e.g., a cathode), and an electrolyte in electrochemical communication with the first electrode and the second electrode. In some embodiments, an electrochemical cell including a separator disposed between the first electrode and the second electrode is provided. The separator, according to some embodiments, comprises porous separator materials that can contain a non-solid electrolyte (e.g., a liquid electrolyte) and/or may itself be the electrolyte (e.g., a solid or gel electrolyte).

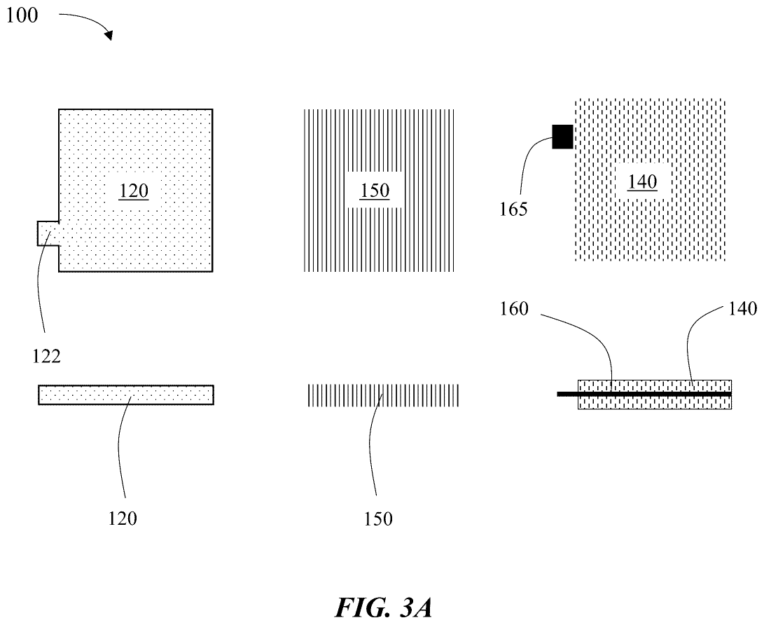

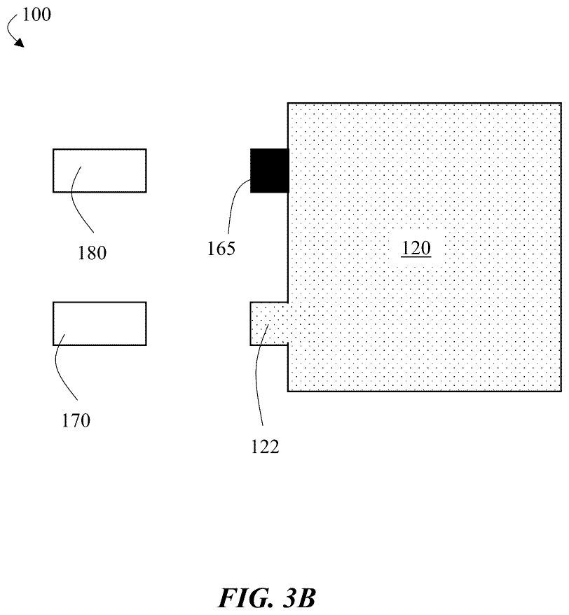

FIGS. 3A-3B show schematic illustrations of exemplary electrochemical devices and components, according to some embodiments. FIG. 3A depicts top-down (upper) and cross-sectional (lower) views of exemplary electrochemical device components, including anode 120, separator 150, and cathode 140, according to some embodiments. The anode may have a configuration of any one of the anode structures described elsewhere herein, such as single-sided anode structure 10 shown in FIG. 1A or double-sided anode structure 40 as shown in FIGS. 2A-2B. Though the below descriptions refer to anode 120 (e.g., a double-sided vapor-deposited lithium metal anode as shown in FIGS. 2A-2B) and cathode 140 (e.g., a double-sided cathode comprising a cathode active material 140 deposited on current collector 160 (e.g., a metal layer)), it should be understood that other configurations are possible, such as embodiments that include cathode structure 120 and anode structure 140.

Anode structure 120 comprises double-sided anode extension portion 122, in accordance with some embodiments, and double-sided anode portion 122 is an extension of the anode structure 120. It should be understood that double-sided anode portion 122 can look like double-sided anode portion 22 in, for example FIGS. 2A-2B. The double-sided anode extension portion 122, according to some embodiments, may comprise two anode extension tabs welded to an end portion of various intermediate layers (e.g., anode electroactive material layer and/or anode current collectors), similar to the anode extension portion 22 shown in FIGS. 2A-2B. Further, in some embodiments, cathode 140 comprises cathode current collector extension portion 165. The various electrochemical device components may be assembled together to form an electrochemical device (e.g., an electrochemical cell), according to some embodiments. For example, the electrochemical cell may comprise the anode 120 positioned adjacent a first side of the separator 150 and the cathode 140 positioned on the second side of the separator 150 opposite the anode 120. The separator, according to some embodiments, may be a porous separator containing a liquid electrolyte and/or may itself be an electrolyte (e.g., a solid electrolyte), as described in more detail below.

FIG. 3B shows a top-down view of an exemplary electrochemical device 100 comprising the anode 120 (including double-sided anode extension portion 122), the separator 150 (hidden behind anode 120), and the cathode 140 (hidden behind the anode 120 and the separator 150, but including the cathode current collector extension portion 165, which is not hidden), according to some embodiments. In some embodiments, a first electrochemical cell tab 170 (e.g., an electrically conductive terminal such as an anode terminal) is electrically coupled to the double-sided extension portion 122 of anode 120 by bringing (e.g., welding) the first electrochemical cell tab 170 into contact with double-sided anode portion 122. In some embodiments, a second electrochemical cell tab 180 (e.g., an electrically conductive terminal such as a cathode terminal) is electrically coupled to current collector extension portion 165 of cathode current collector 160 shown in FIG. 3A, such that a complete electrical circuit involving electrochemical device 100 is established. The double-sided electrode extension portion 122 may comprise two anode extension tabs (e.g., first and second anode extension tabs 18A and 18B shown in FIG. 2A) welded to the anode electroactive material layers (e.g., first and second anode electroactive material layers 14A and 14B) and anode current collectors (e.g., first and second anode current collectors 12A and 12B), as shown in FIG. 2A

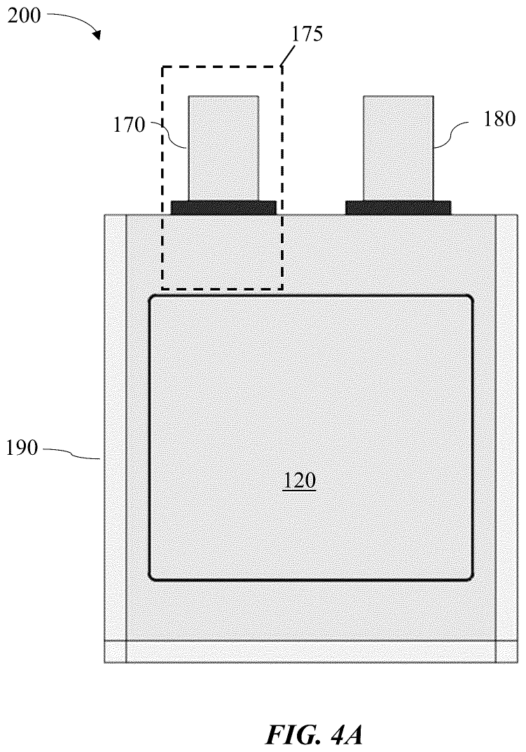

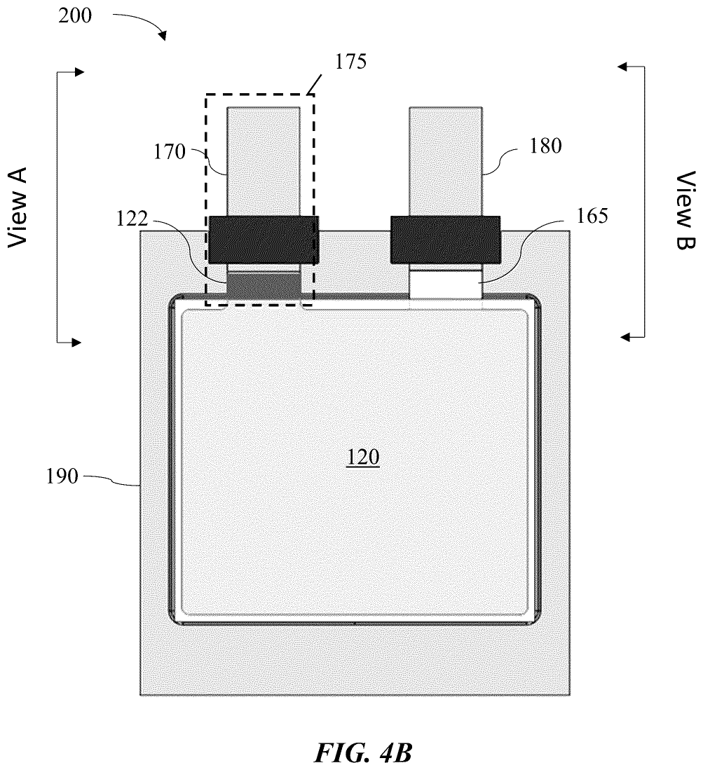

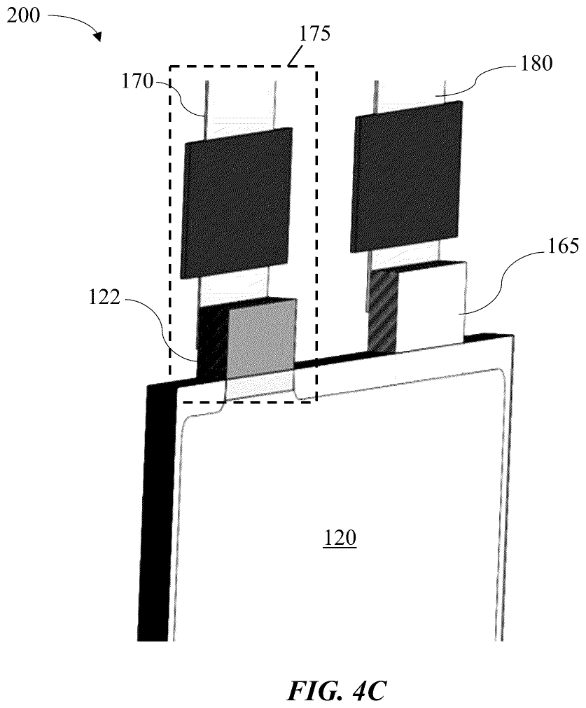

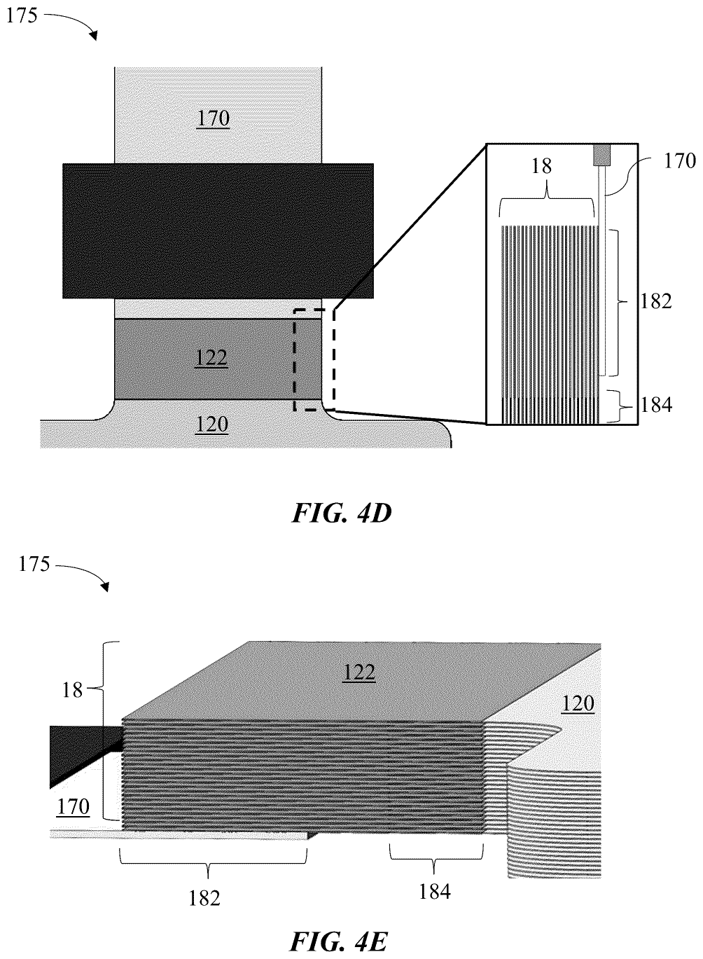

In some embodiments, an electrochemical device (e.g., an electrochemical cell and/or battery) may comprises a plurality of the components shown in FIGS. 3A-3B, such as a plurality of anodes 120, cathodes 140, and separators 150 comprising an electrolyte. The plurality of anode structures 120, according to some embodiments, may be arranged or stacked in an alternating fashion with the plurality of cathodes 140, and the plurality of separators 150 may be interposed between each alternating layers of anode and cathode, according to some embodiments. A non-limiting example of one such embodiment of an electrochemical device is shown in FIGS. 4A-4C.

FIGS. 4A-4C show, respectively, a top view, a top-down view, and a perspective view of an electrochemical device 200 containing a plurality of anode structures described herein. The electrochemical device 200 may have a stacked configuration and may comprise various components (e.g., components shown in FIGS. 3A-3B) arranged in an alternating fashion: anode 120, separator 150 (not shown), cathode 140 (not shown), separator 150 (not shown), anode 120 (not shown), separator 150 (not shown), etc. The plurality of anodes in electrochemical device 200 may each comprise an anode extension portion 122 that is coupled to (e.g., welded to) the first electrochemical cell tab 170 (e.g., an anode terminal). Similarly, the plurality of cathodes in electrochemical device 200 may each comprise a cathode current collector extension portion 165 that is coupled to the second electrochemical cell tab 180 (e.g., a cathode terminal), such that a complete electrical circuit involving electrochemical device 200 is established. The electrochemical device 200 may further comprise an enclosure 190 (e.g., a pouch) configured to house the stacked electrochemical components described herein. The various connections between the plurality of anodes 120 and the first electrochemical cell tab 170 are illustrated in more details in FIGS. 4D-4E.

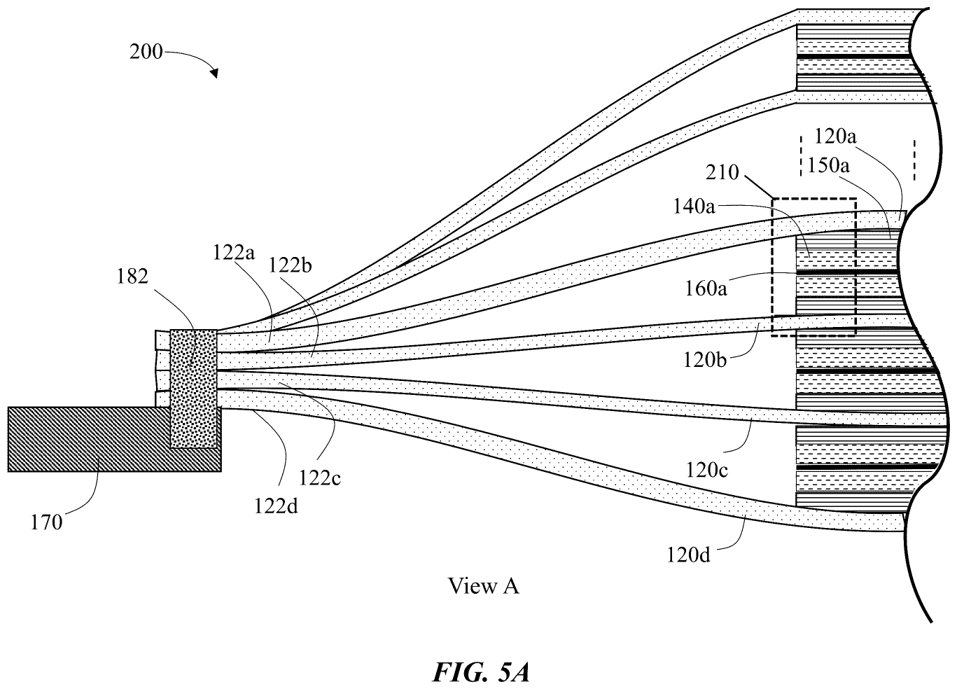

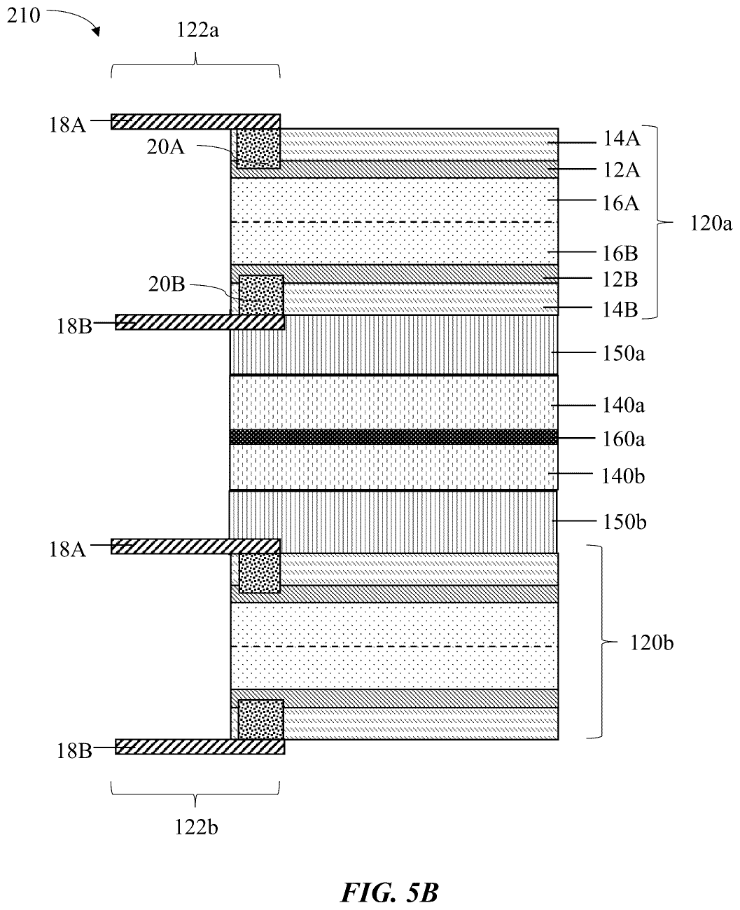

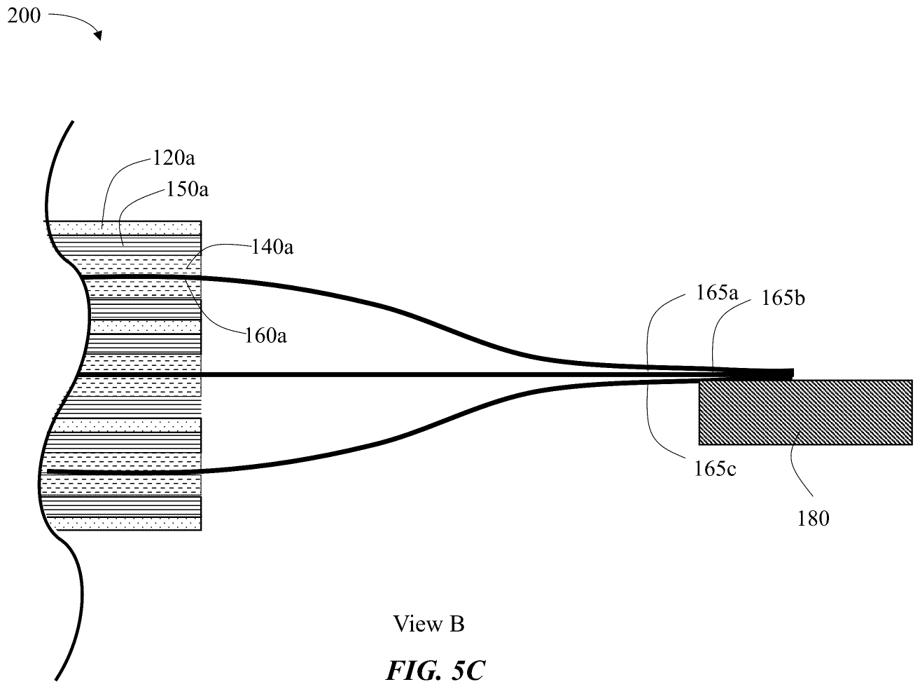

For example, FIGS. 4D-4E show, respectively, a top view and a perspective view of an anode portion 175 of the electrochemical cell 200 shown in FIGS. 4A-4C, according to some embodiments. As shown, each of the plurality of anode extension tabs 18 within the anode extension portion 122 are individually welded to each anode 120 at a region 184 (e.g., a first weld zone). As shown, the plurality of anode extension tabs 18 within anode extension portion 122 extending from the plurality of anodes 120 are together coupled to (e.g., welded to) the first electrochemical cell tab 170 at a region 182 (e.g., a second weld zone), such that electrical communication is established between the anodes and the anode terminal, according to some embodiments. Any of a variety of appropriate welding methods described elsewhere herein may be employed to from a weld between the plurality of anode extension portions and the first electrochemical cell tab. The plurality of anodes shown in FIGS. 4A-4E may be either a single-sided anode structure (e.g., anode structure 10 shown in FIG. 1A) or a double-sided anode structure (e.g., anode structure 40 shown in FIG. 2A). As an illustrative example, FIGS. 5A-5C show an electrochemical device comprising a plurality of double-sided anode structures.

FIG. 5A shows a schematic cross-sectional illustration of the electrochemical device 200 as viewed from View A shown in FIG. 4B, in accordance with some embodiments. As shown in FIG. 5A, electrochemical device 200 has a stacked configuration and comprises the following components in arranged in order: double-sided anode 120a, separator 150a, and cathode 140a comprising current collector 160a, in accordance with some embodiments. In some cases, this arrangement of components is repeated in electrochemical device 200. It should be understood that each of the double-sided anodes (e.g., double-sided anode 120a, 120b, 120c, and 120d shown in FIG. 5A) can look like double-sided anode 40 in, for example FIGS. 2A-2B, and are shown as single layers in FIG. 5A for clarity of illustration. As shown in FIG. 5A, the anode extension portions (e.g., anode extension portion 122a, 122b, 122c, 122d) of the anodes may extend past the other components of electrochemical device 200, according to some embodiments. As shown in FIG. 5A, additional double-sided anode portions may be stacked on top of the double-sided anode 120a with intervening layers (cathode, separators) arranged in an alternating fashion as described above. For example, an additional separator (e.g., not shown) may be disposed on the double-sided anode 120a at a side opposite the separator 150a, followed by an additional cathode (e.g., cathode similar to cathode 140a comprising current collector 160) disposed on a side of the additional separator opposite the double-sided anode 120a. Additional layers may be stacked on the double-sided anode 120a repetitively in the following alternating order: separator, cathode comprising a current collector, separator, double-sided anode, etc. While not shown in FIG. 5A, it should be understood that additional double-sided anode portions may also be stacked on the double-sided anode 120d in the same way as for the double-sided anode 120a, with intervening layers (e.g., cathode, separators) arranged in the same order as described above. A sectional view of portion 210 of the electrochemical device 200 is shown in FIG. 5B to better illustrate the arrangement within the electrochemical device.

As shown in FIG. 5B, the anodes 120a and 120b may have the structure of the double-sided anode 40 shown in FIGS. 2A-2B. For example, in some embodiments, double-sided anode 120a in FIG. 5A comprises two anode current collectors (e.g., first and second anode current collector 12A and 12B) positioned on opposite sides of one or more electrically non-conductive layers (e.g., first and/or second electrically non-conductive layers 16A and 16B). Double-sided anode 120a further comprises two anode electroactive material layers (e.g., first and second anode electroactive material layers 14A and 14B), each comprising a lithium film (e.g., a VDLi film), positioned adjacent the corresponding anode current collector (e.g., first and second anode current collector 12A and 12B) at a side opposite the electrically non-conductive layer (e.g., first and second electrically non-conductive layers 16A and 16B), according to some embodiments. The double-sided anode 120a further comprises a double-sided anode extension portion 122a comprising two anode extension tabs (e.g., first and second anode extension tabs 18A and 18B), each positioned adjacent a corresponding anode electroactive material layer (e.g., first and second anode electroactive material layers 14A and 14B) at a side opposite a corresponding anode current collector (e.g., first and second anode current collector 12A and 12B). Each of the anode extension tabs (e.g., first and second anode extension tabs 18A and 18B) may form a weld (e.g., first and second weld 20A and 20B) through a portion of the corresponding anode electroactive material layer (e.g., first and second anode electroactive material layers 14A and 14B) between at least a portion of the corresponding anode extension tab (e.g., first and second anode extension tabs 18A and 18B) and at a least a portion of the corresponding anode current collector (e.g., anode current collector 12A and 12B), according to some embodiments.

As shown in FIG. 5A, the plurality of anode structures 120a and 120b may be joined to each other such that their plurality of anode extension tabs 18A and 18B are arranged in a multilayered configuration. Furthermore, as shown in FIGS. 5A-5B, the plurality of anode extension tabs within each double-sided anode extension portions (e.g., portions 122a, 122b, 122c, 122d) may extend past the other components (e.g., cathode 140a, 140b, and cathode current collector 160a) and an end portion of the anode extension tabs may be joined (e.g., welded) to the first electrochemical cell tab 170 (e.g., an anode terminal) at region 182. Accordingly, as shown in FIG. 5A, the plurality of anodes (e.g., anodes 120a, 120b, 120c, 120d) are electrically coupled to each other via the plurality anode extension tabs joined with the first electrochemical cell tab 170.

FIG. 5C shows a schematic cross-sectional illustration of electrochemical device 200 as viewed from View B shown in FIG. 4B, in accordance with some embodiments. In FIG. 5C, cathode current collector extensions (e.g., extensions 165a, 165b, 165c, 165d) extends past the other components (e.g., anode 120a, separator 150a, cathode 140a, etc.) of the electrochemical device 200, and can, in some cases, be used to form an electrical connection with an electrochemical cell tab (e.g., a second electrochemical cell tab 180 shown in FIG. 5C).

As mentioned above, the anode structure may comprise at least one anode extension tab (e.g., first anode extension tab 18A and/or second anode extension tab 18B as shown in FIGS. 1-2B). The anode extension tab may comprise any of a variety of appropriate metals and/or metal alloys (e.g., non-electroactive materials) capable of being welded to the anode current collector. In some embodiments, the anode extension tab comprises a metal and/or metal alloy comprising one or more of copper, aluminum, and/or nickel. In some embodiments, the anode extension tab comprises a corrosion-resistive metal (e.g., copper) and/or metal alloy (e.g., copper alloy). In some embodiments, the at least one anode extension tab may comprise a metal (or a metal alloy) present in the at least one anode current collector. In one embodiment, the one or more anode extension tabs may comprise a metal (or metal alloy) identical to the metal (or metal alloy) in the anode current collector adjacent to the anode extension tab. Without wishing to be bound by any particular theory, it is believed that an anode extension tab comprising at least one or more identical metal(s) metal alloys as the adjacent anode current collector may be more readily welded to the adjacent anode current collector and may result in the formation of a weld having an enhanced mechanical strength. For example, as shown in FIGS. 1-2B, the first anode extension tab 18A may comprise one or more metal(s) present in the first anode current collector 12A and/or the second anode extension tab 18B may comprise a metal present in the second anode current collector 12B. Alternatively, according to some embodiments, the one or more anode extension tab(s) may comprise a metal (or metal alloy) different from the metal (or metal alloy) in the anode current collector(s) adjacent to the anode extension tab(s).

The at least one anode extension tab may have any of a variety of appropriate dimensions. In some embodiments, the one or more anode extension tab(s) may have a thickness of greater than or equal to 2 microns, greater than or equal to 4 microns, greater than or equal to 6 microns, greater than or equal to 8 microns, greater than or equal to 10 microns, greater than or equal to 15 microns, greater than or equal to 20 microns, greater than or equal to 25 microns, greater than or equal to 30 microns, or greater than or equal to 35 microns. In some embodiments, the one or more anode extension tab(s) may have a thickness of less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 8 microns, less than or equal to 6 microns, or less than or equal to 4 microns. Combinations of the above-referenced ranges are possible (e.g., greater than or equal to 2 microns and less than or equal to 40 microns). Other ranges are also possible.

In some embodiments, the at least one anode extension tab (e.g., the first and/or second metal extension tab in FIGS. 1-2B) comprises an overhang portion that extends from an end portion (e.g., the edge) of an adjacent electroactive material layer. For example, as shown in FIGS. 1-2B, the first anode extension tab 18A and/or the second anode extension tab 18B comprise(s) an overhang portion (e.g., portion L) extending outward from an edge of the corresponding electroactive material layer, e.g., the first anode electroactive material layer 14A and/or the second anode electroactive material layer 14B. The overhang portion may have any appropriate dimensions.

As mentioned above, the anode structure may comprise at least one weld (e.g., first weld 20A and/or second weld 20B) formed through an adjacent electroactive material layer (e.g., layer 14A and/or 14B) between at least a portion of an adjacent anode extension tab (e.g., tab 18A and/or 18B) and an adjacent anode current collector (e.g., anode current collector 12A and/or 12B). In some embodiments, the at least one weld is configured protrude through the adjacent electroactive material layer and into at least a portion of the corresponding anode current collector. For example, as shown in FIGS. 1-2C, the first weld 20A and/or the second weld 20B is configured protrude through the corresponding electroactive material layer (e.g., first electroactive material layer 14A and/or second electroactive material layer 14B) and into at least a portion of the corresponding anode current collector (e.g., anode current collector 12A and/or 12B). In some embodiments, the at least one weld may protrude into the corresponding anode current collector to a depth that is greater than or equal to 5%, greater than or equal to 10%, greater than or equal to 20%, greater than or equal to 30%, greater than or equal to 40%, greater than or equal to 50%, greater than or equal to 60%, greater than or equal to 70%, greater than or equal to 80%, or greater than or equal to 90% of the thickness of the anode current collector. In some embodiments, the at least one weld may protrude into the corresponding anode current collector at a depth that is less than or equal to 100%, less than or equal to 95%, less than or equal to 90%, less than or equal to 80%, less than or equal to 70%, less than or equal to 60%, less than or equal to 50%, less than or equal to 30%, less than or equal to 20%, or less than or equal to 10% of the thickness of the anode current collector. Combinations of the above-referenced ranges are possible (e.g., greater than or equal to 5% and less than or equal to 100%, or greater than or equal to 5% and less than or equal to 95%). Other ranges are also possible.

In some embodiments, the weld does not contact and/or is not formed through (e.g., penetrate) the adjacent electrically non-conductive layer. For example, as shown in

FIGS. 1-2B, the first weld 18A does not contact and/or is not formed through the first electrically non-conductive layer 16A and/or the electrically non-conductive layer 16, according to some embodiments. Similarly, the second weld 18B does not contact and/or is not formed through the second electrically non-conductive layer 16B and/or the electrically non-conductive layer 16, according to some embodiments.

The at least one weld described herein may have any of a variety of appropriate thicknesses. In some embodiments, the at least one weld may have a thickness that is greater than or equal to the thickness of the anode extension tab and less than or equal to the total thickness of the anode extension tab, the anode electroactive material layer, and the anode current collector.

In some embodiments, the at least one weld may have a relatively high mechanical strength (e.g., compressional, tensile, flexural, and yield strength). In some embodiments, the at least one weld may have a mechanical strength of greater than or equal to 0.01 GPa, greater than or equal to 0.1 GPa, greater than or equal to 0.5 GPa, greater than or equal to 1 GPa, greater than or equal to 5 GPa, greater than or equal to 10 GPa, greater than or equal to 50 GPa, greater than or equal to 100 GPa, or more. In some embodiments, the at least one weld may have a mechanical strength of less than or equal to 100GPa, less than or equal to 50 GPa, less than or equal to 10 GPa, less than or equal to 5 GPa, less than or equal to 1 GPa, less than or equal to 0.5 GPa, less than or equal to 0.1 GPa, or less. Combinations of the above-referenced ranges are possible (e.g., greater than or equal to 0.01 GPa and less than or equal to 100 GPa). Other ranges are also possible.

It has been recognized, in the context of the present disclosure, that it would be useful to be able to join thin, sheet-like materials via welding. For example, methods of welding via ultrasonic welding and/or resistance welding have been identified, in the context of the present disclosure, that produce, in some instances, thin, low-defect welds with relatively low electronic resistance. The methods disclosed herein can, in some instances, be used to prepare area welds without adversely cutting, cracking, or pitting the metal materials.

Some of the welds described herein may have favorable properties for use in electronics. For example, some of the welds described herein may have a low electronic resistance when compared with welds or joints formed by other techniques (e.g., formed by soldering, formed by TIG welding). The term “resistance” is used herein to refer to an article's resistance to the flow of electrons (electronic resistance). In general, resistance is normalized by an article's geometry to determine resistivity of the material comprising the article. In the present disclosure, the terms resistivity, conductivity, and resistance may all be used when discussing the ability of an article to permit the flow of electrons. An article's sheet resistance is its electronic resistance multiplied by its length in the direction of electron conduction and divided by its width in an in-plane direction of the sheet, perpendicular to the direction of electron conduction. The resistance, resistivity, and/or sheet resistance of a weld can be measured using a four-point probe.

In some embodiments, a resistance of a weld formed by a method described herein is less than or equal to 100%, less than or equal to 75%, less than or equal to 50%, less than or equal to 25%, less than or equal to 15%, or less of a resistance observed when the first electrochemical cell tab and the second electrochemical cell tab are directly adjacent in an otherwise identical configuration, but are not welded. In some embodiments, a resistance of a formed weld is greater than or equal to 1%, greater than or equal to 5%, greater than or equal to 10%, or greater than or equal to 15% of a resistance observed when the first electrochemical cell tab and the second electrochemical cell tab are directly adjacent in an otherwise identical configuration but are not welded. Combinations of these ranges are possible. For example, a resistance of a formed weld may be greater than or equal to 1% and less than or equal to 100% of a resistance observed when the first electrochemical cell tab and the second electrochemical cell tab are directly adjacent in an otherwise identical configuration, but are not bound.

In some embodiments, a resistivity of a formed weld is greater than or equal to 1.0×10⁻⁹ Ohm-m, greater than or equal to 1.0×10⁻⁸ Ohm-m, greater than or equal to 5.0×10⁻⁸ Ohm-m, greater than or equal to 1.0×10⁻⁷ Ohm-m, or greater. In some embodiments, a resistivity of a formed weld is less than or equal to 1.0×10⁻⁵ Ohm-m, less than or equal to 5.0×10⁻⁶ Ohm-m, less than or equal to 1.0×10⁻⁶ Ohm-m, less than or equal to 5.0×10⁻⁷ Ohm-m, less than or equal to 1.0×10⁻⁷ Ohm-m, or less. Combinations of these ranges are possible. For instance, in some embodiments, the resistivity of the formed weld is greater than or equal to 1.0×10⁻⁹ Ohm-m and less than or equal to 1.0×10⁻⁵ Ohm-m.

In some embodiments, a sheet resistance of a formed weld is greater than or equal to 1.0×10⁻⁹ Ohm-m, greater than or equal to 1.0×10⁻⁸ Ohm-m, greater than or equal to 5.0×10⁻⁸ Ohm-m, greater than or equal to 1.0×10⁻⁷ Ohm-m, or greater. In some embodiments, a sheet resistance of a formed weld is less than or equal to 1.0×10⁻⁵ Ohm-m, less than or equal to 5.0×10⁻⁶ Ohm-m, less than or equal to 1.0×10⁻⁶ Ohm-m, less than or equal to 5.0×10⁻⁷ Ohm-m, less than or equal to 1.0×10⁻⁷ Ohm-m, or less. Combinations of these ranges are possible. For instance, in some embodiments, the sheet resistance of the formed weld is greater than or equal to 1.0×10⁻⁹ Ohm-m and less than or equal to 1.0×10⁻⁵ Ohm-m.

The electrochemical cell tabs described herein may comprise any of a variety of appropriate materials. For example, in some embodiments, the electrochemical cell tabs described herein comprise metals and/or metal alloys. The electrochemical cell tab, for example, may comprise aluminum, copper, nickel, gold, and/or alloys of aluminum, copper, nickel, or gold. The electrochemical cell tab may or may not be plated. For example, in some embodiments, an electrochemical cell tab is nickel-plated copper, and another electrochemical tab is un-plated copper. Any of a variety of welding techniques may be employed to weld the plurality of anode extension tabs (e.g., anode extension tabs 18A, 18B shown in FIGS. 1A-5C) within the anode extension portions (e.g., anode extension portion 22, 122 shown in FIGS. 1A-5C) to the electrochemical cell tab, such as ultrasonic welding, laser welding, and/or spot welding (i.e., resistance welding).

As mentioned above, in some cases, the electrically non-conductive layer is or comprises a release layer. Details of exemplary materials and properties of release layers are described in more detail below. The release layer may comprise a polymeric material, and the release layer may be used as part of a fabrication step of one or more components of an article and/or electrochemical device described herein. For example, in some cases, it is convenient to form an electrode portion to be used in an electrochemical device by depositing or coating the electrode material onto a release layer on a substrate (e.g., a substrate used as a solid surface upon which some components of the article and/or electrochemical device are formed during fabrication, but not necessarily included in the finished article or electrochemical device), and subsequently to use the release layer to separate the deposited or coated electrode portion from the substrate (e.g., so that it can be incorporated into an electrochemical device such as a battery). As one non-limiting example, an anode comprising lithium and/or a lithium alloy as an anode active material may be formed by vapor depositing lithium onto a release layer that is on a substrate, followed by separating the release layer (and a resulting layer of vapor-deposited lithium or lithium alloy) from the substrate. One example of such an anode is described in U.S. Patent Publication No. US 2008/0014501, published on Jan. 17, 2008, filed as application Ser. No. 11/781,915 on Jul. 23, 2007, patented as U.S. Pat. No. 8,753,771 on Jun. 17, 2014, and entitled “Lithium Anodes for Electrochemical Cells”, which is incorporated herein by reference in its entirety and for all purposes.

The electrically non-conductive layer (e.g., a release layer) described herein may have any of a variety of appropriate thicknesses. In some embodiments, the electrically non-conductive described herein may have a relatively small thickness. In some embodiments, an electrically non-conductive may have a thickness of greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 5 microns, greater than or equal to 6 microns, greater than or equal to 8 microns, greater than or equal to 10 microns, greater than or equal to 12 microns, or greater than or equal to 14 microns. In some embodiments, an electrically non-conductive may have a thickness of less than or equal to 20 microns, less than or equal to 16 microns, less than or equal to 14 microns, less than or equal to 12 microns, less than or equal to 10 microns, less than or equal to 8 microns, less than or equal to 6 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron. Combination of the above-referenced ranges are possible (e.g., greater than or equal to 2 microns and less than or equal to 16 microns). Other ranges are also possible.

The electrically non-conductive layer may comprise any of a variety of insulating materials (e.g., polymers) having both a low electronic conductivity and ionic conductivity. Non-limiting examples of insulating polymers include, but are not limited to poly vinyl alcohol, polyethylene terephthalate, polyolefins (e.g., polypropylene, polyethylene), polyester, polyimide, polysulfone, polyurethane, derivatives or combination thereof. Additional examples include any appropriate polymers having a low electronic conductivity and ionic conductivity. For instance, the polymer may have an ionic conductivity and/or electronic conductivity each of which may be independently less than or equal to 10⁻⁶ S/cm (e.g., less than or equal to 10⁻⁸ S/cm, less than or equal to 10⁻¹⁰ S/cm, less than or equal to 10⁻¹² S/cm, less than or equal to 10⁻¹⁴ S/cm, or less than or equal to 10⁻¹⁶ S/cm, less than or equal to 10⁻¹⁸ S/cm, or less than or equal to less than or equal to 10⁻²⁰ S/cm).

In some embodiments, an electrode or an electrochemical cell includes one or more release layers. For example, in some cases, the electrically non-conductive layer described above (e.g., between the first electrode portion and the second electrode portion) may be or comprise a release layer. Release layers described herein can be configured to have one or more of the following features: relatively good adhesion to a first layer (e.g., an electrode active material, a current collector, or a substrate or other layer) but relatively moderate or poor adhesion to a second layer (e.g., a substrate, or in other embodiments, a current collector or other layer); high mechanical stability to facilitate delamination without mechanical disintegration; high thermal stability; and compatibility with processing conditions (e.g., deposition of layers on top of the release layer, as well as compatibility with techniques used to form the release layer). Release layers may be thin (e.g., less than 10 microns) to reduce overall weight (e.g., battery weight) if the release layer is incorporated into an electrochemical device (e.g., comprising an electrochemical cell). A release layer should generally also be smooth and uniform in thickness so as to facilitate the formation of uniform layers on top of the release layer. Furthermore, release layers should generally be stable in the electrolyte and should generally not interfere with the structural integrity of the electrodes in order for the electrochemical device to have a high electrochemical “capacity” or energy storage capability (i.e., reduced capacity fade). The use of release layers to remove a substrate from one or more components of an electrochemical cell are described in detail in U.S. patent application Ser. No. 12/862,513, filed on Aug. 24, 2010, entitled “Release System for Electrochemical Cells.”

The release layer may be formed of, for example, a ceramic, a polymer, or a combination thereof. In some embodiments, the substrate and/or release layer comprises a polymeric material. In some cases, at least a portion of the polymeric material of the release layer is crosslinked; in other cases, the polymeric material(s) is substantially uncrosslinked. Examples of polymeric materials include, for example, hydroxyl-containing polymers such as poly vinyl alcohol (PVOH), polyvinyl butyral, polyvinyl formal, vinyl acetate-vinyl alcohol copolymers, ethylene-vinyl alcohol copolymers, and vinyl alcohol-methyl methacrylate copolymers.

As mentioned, the anode structures described herein may comprises a substrate upon which the electrically non-conductive layer(s) is deposited on. The substrate, according to some embodiments, may be electrically non-conductive and may have any material properties and dimensions described elsewhere herein with respect to the electrically non-conductive layer(s).

As noted above, the anode electroactive material layer described herein may comprise a lithium film (e.g., containing lithium metal or lithium alloys such as aluminum alloys and lithium-tin alloys), according to some embodiments. To form the lithium film, lithium may be vapor deposited onto the anode current collector or deposited any other suitable method. Non-limiting examples of vapor deposition methods include, but are not limited to, physical vapor deposition, chemical vapor deposition, and/or aerosol deposition method (ADM).

Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium (e.g., lithium metal and/or a lithium metal alloy) during a portion of a charging and/or discharging process of the electrochemical cell, but is free of lithium metal and/or a lithium metal alloy at a completion of a discharging process. In some embodiments, the anode active material contains at least 50 wt % lithium. In some cases, the anode active material contains at least 75 wt %, at least 90 wt %, at least 95 wt %, or at least 99 wt % lithium.

While the various embodiments disclosed herein are directed to anode structures comprising VDLi based anodes, it should be understood the disclosure is not so limited, and that in other embodiments, the various anode structures (e.g., as shown in FIGS. 1A-2B) described herein may also comprise other types of electroactive material layers (e.g., non-VDLi based anodes). For example, in some embodiments, the anode active material comprises lithium (e.g., lithium metal), such as lithium foil. Alternatively, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In some cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In some embodiments, the anode active material comprises silicon, lithium, and/or any alloys of combinations thereof. In some embodiments, the anode active material comprises lithium titanate (Li₄Ti₅O₁₂, also referred to as “LTO”), tin-cobalt oxide, or any combinations thereof.

The anode electroactive material layer comprising lithium film described herein (e.g., first and second electroactive material layers 14A and/or 14B) may have any of a variety of appropriate thicknesses. In some embodiments, the anode electroactive material layer comprising lithium film may have a thickness of greater than or equal to 2 microns, greater than or equal to 5 microns, greater than or equal to 6 microns, greater than or equal to 8 microns, greater than or equal to 10 microns, greater than or equal to 12 microns, greater than or equal to 14 microns, greater than or equal to 16 microns, greater than or equal to 18 microns, greater than or equal to 20 microns, greater than or equal to 22 microns, or greater than or equal to 25 microns. In some embodiments, the anode electroactive material layer comprising lithium film may have a thickness of less than or equal to 30 microns, less than or equal to 25 microns, less than or equal to 22 microns, less than or equal to 20 microns, less than or equal to 18 microns, less than or equal to 16 microns, less than or equal to 14 microns, less than or equal to 12 microns, less than or equal to 10 microns, less than or equal to 8 microns, less than or equal to 6 microns, less than or equal to 5 microns, or less than or equal to 4 microns. Combination of the above-referenced ranges are possible (e.g., greater than or equal to 6 microns and less than or equal to 25 microns). Other ranges are also possible.

The anode current collector described herein (e.g., anode current collectors 16, 16A, and/or 16B as shown in FIGS. 1-2B) may comprise any of a variety of appropriate materials. Materials for the current collector may be selected, in some cases, from conductive metals (e.g., copper, nickel, aluminum, passivated metals, and other appropriate metals), metallized polymers, electrically conductive polymers, polymers comprising conductive particles dispersed therein, and other appropriate materials. In one set of embodiments, the one or more anode current collectors comprises copper and/or aluminum. In some embodiments, the current collector material is deposited onto the electrically non-conductive using vacuum deposition, physical vapor deposition, chemical vapor deposition, electrochemical deposition, sputtering, doctor blading, flash evaporation, or any other appropriate deposition technique for the selected material.

The anode current collectors described herein may have any of a variety of appropriate thicknesses. In some embodiments, an anode current collector may have a thickness of greater than or equal to 0.01 microns, greater than or equal to 0.025 microns, greater than or equal to 0.05 microns, greater than or equal to 0.1 microns, greater than or equal to 0.2 microns, greater than or equal to 0.3 microns, greater than or equal to 0.4 microns, greater than or equal to 0.6 microns, greater than or equal to 0.8 microns, greater than or equal to 1 micron, greater than or equal to 2.0 microns, greater than or equal to 3 microns, greater than or equal to 4 microns, greater than or equal to 5 microns, or greater than or equal to 7.5 microns. In some embodiments, an anode current collector may have a thickness of less than or equal to 10 microns, less than or equal to 7.5 microns, less than or equal to 5 microns, less than or equal to 4 microns, less than or equal to 3 microns, less than or equal to 2 microns, less than or equal to 1.5 microns, less than or equal to 1 micron, less than or equal to 0.8 microns, less than or equal to 0.6 microns, less than or equal to 0.4 microns, less than or equal to 0.3 microns, less than or equal to 0.2 microns, less than or equal to 0.1 microns, less than or equal to 0.05 microns, or less than or equal to 0.025 microns. Combination of the above-referenced ranges are possible (e.g., greater than or equal to 0.01 microns and less than or equal to 10 microns, greater than or equal to 0.01 microns and less than or equal to 0.3 microns). Other ranges are also possible.

A variety of cathode active materials are suitable for use with cathodes of the electrochemical cells described herein, according to some embodiments. In some embodiments, the cathode active material comprises a lithium intercalation compound (e.g., a compound that is capable of reversibly inserting lithium ions at lattice sites and/or interstitial sites). In some cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In some embodiments, the cathode active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In some cases, the electroactive material of the second electrode comprises Li_{1.14}Mn_{0.42} Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material comprises a conversion compound. For instance, the cathode may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material may be doped with one or more dopants to alter the electrical properties (e.g., electrical conductivity) of the cathode active material. Non-limiting examples of suitable dopants include aluminum, niobium, silver, and zirconium.

In some embodiments, the cathode active material may be modified by a surface coating comprising an oxide. Non-limiting examples of surface oxide coating materials include: MgO, Al₂O₃, SiO₂, TiO₂, ZnO₂, SnO₂, and ZrO₂. In some embodiments, such coatings may prevent direct contact between the cathode active material and one or more components of the electrolyte, thereby suppressing side reactions.

In some embodiments, the cathode active material comprises sulfur. In some embodiments, the cathode active material comprises electroactive sulfur-containing materials. “Electroactive sulfur-containing materials,” as used herein, refers to electrode active materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within an electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, each of which is incorporated herein by reference in its entirety for all purposes. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., each of which is incorporated herein by reference in its entirety for all purposes. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., each of which is incorporated herein by reference in its entirety for all purposes.

One or more electrodes may further comprise additional additives, such as conductive additives, binders, etc., as described in U.S. Pat. No. 9,034,421 to Mikhaylik et al.; and U.S. Patent Application Publication No. 2013/0316072, each of which is incorporated herein by reference in its entirety for all purposes.

In some embodiments, the cathode current collector comprises an electron conductive material comprising one or more of Al, Ti, Ni, and carbon. The cathode current collectors described herein may have any of a variety of appropriate thicknesses. In some embodiments, a cathode current collector may have a thickness of greater than or equal to 0.1 microns, greater than or equal to 0.2 microns, greater than or equal to 0.4 microns, greater than or equal to 0.6 microns, greater than or equal to 0.8 microns, greater than or equal to 1 micron, greater than or equal to 2 microns, greater than or equal to 3 microns, greater than or equal to 4 microns, greater than or equal to 5 microns, greater than or equal to 6 microns, or greater than or equal to 7.5 microns. In some embodiments, a cathode current collector may have a thickness of less than or equal to 10 microns, less than or equal to 7.5 microns, less than or equal to 6 microns, less than or equal to 5 microns, less than or equal to 4 microns, less than or equal to 3 microns, less than or equal to 2 microns, less than or equal to 1 micron, less than or equal to 0.8 microns, less than or equal to 0.6 microns, less than or equal to 0.4 microns, less than or equal to 0.2 microns, or less than or equal to 0.1 microns. Combination of the above-referenced ranges are possible (e.g., greater than or equal to 0.1 microns and less than or equal to 10 microns, or greater than or equal to 0.2 microns and less than or equal to 5 microns, or greater than or equal to 0.2 microns and less than or equal to 1 micron). Other ranges are also possible.

Any of a variety of materials can be used as an electrolyte, in embodiments in which an electrolyte is present. The electrolyte can comprise, for example, a solution of ions, a solid electrolyte, a gel electrolyte, and/or a combination of these.

In some embodiments, the electrochemical cells further comprise a separator between two electrode portions (e.g., an anode portion and a cathode portion). The separator may be a solid non-conductive or insulative material, which separates or insulates the anode and the cathode from each other preventing short circuiting, and which permits the transport of ions between the anode and the cathode. In some embodiments, the porous separator may be permeable to the electrolyte.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known In the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function. For example, in one set of embodiments, the one or more separators may be a ceramic solid state electrolyte.

As mentioned, the electrochemical cells described herein may comprise an electrolyte. The electrochemical cell may comprise any of the anode structures describe elsewhere herein, such as anode structure 10 and 40 as shown in FIGS. 1-2B. The electrochemical cell described herein may comprise any of a variety of components, including, but not limited to, a first electrode, a second electrode, and/or an electrolyte. FIG. 3A illustrates an example of one such set of embodiments. As shown in FIG. 3A, electrochemical cell 110 comprises first electrode 120 (e.g., an anode), second electrode 140 (e.g., a cathode), and an electrolyte or separator 150 in electrochemical communication with (and disposed between) first electrode 120 and second electrode 140. In some embodiments, the electrolyte may be a liquid electrolyte, a gel electrolyte, or a solid electrolyte, contained within a separator.

The electrolyte can function as a medium for the storage and transport of ions, and in the special case of solid electrolytes and gel electrolytes, these materials may additionally function as a separator between an anode and a cathode. Any liquid, solid, or gel material capable of storing and transporting ions may be used, so long as the material facilitates the transport of ions (e.g., lithium ions) between an anode and the cathode. The electrolyte is electrically non-conductive to prevent short circuiting between an anode and a cathode. In some embodiments, the electrolyte may comprise a non-solid electrolyte.

In some embodiments, the electrolyte comprises a fluid that can be added at any point in the fabrication process. In some cases, the electrochemical cell may be fabricated by providing a cathode and an anode, applying an anisotropic force component normal to the active surface of the anode, and subsequently adding the fluid electrolyte such that the electrolyte is in electrochemical communication with the cathode and the anode. In other cases, the fluid electrolyte may be added to the electrochemical cell prior to or simultaneously with the application of an anisotropic force component, after which the electrolyte is in electrochemical communication with the cathode and the anode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. patent application Ser. No. 12/312,764, filed May 26, 2009 and entitled “Separation of Electrolytes,” by Mikhaylik et al., which is incorporated herein by reference in its entirety.

Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes, for example, in lithium cells. Aqueous solvents can include water, which can contain other components such as ionic salts. As noted above, in some embodiments, the electrolyte can include species such as lithium hydroxide, or other species rendering the electrolyte basic, so as to reduce the concentration of hydrogen ions in the electrolyte.

In one set of embodiments, the solvent comprises at least one fluorinated organic solvent. In some embodiments, a fluorinated organic solvent and/or a mixture of fluorinated organic solvent is used as the sole solvent in the electrolyte. In some embodiments, the at least one fluorinated organic solvent is selected from group of cyclic and linear fluorinated carbonates, fluorinated ethers, and fluorinated esters (e.g., fluorinated alkyl esters). For example, in one embodiment, the solvent comprises at least one fluorinated organic solvent that is selected from fluoroethylene carbonate and/or difluoroethylene carbonate. Additional non-limiting examples of fluorinated organic solvent include, but are not limited to, methyl, 2,2,2,-trifluoroethyl carbonate, 1,1,2,2,-tetrafluoroethyl 2,2,2-trifluoroethylether, 1,1,2,2-tetrafluoroethyl-2,2,3,3-tetrafluoropropylether, methyl difluoroacetate, ethyl difluoroacetate, methyl trifluoroacetate, and ethyl trifluoroacetate.

In some embodiments, the solvent further comprises at least one non-fluorinated organic solvent. In some embodiments, the at least one non-fluorinated organic solvent comprises ester-based solvents. In some embodiments, the organic solvent may comprise one or more of esters of carboxylic acids, esters of phosphoric acid, linear and cyclic ethers and acetals, esters of sulfuric acids, esters of sulfonic acids, esters formed from carboxylic acids and halogenated alcohols, and alkyl esters. In some embodiments, the at least one non-fluorinated organic solvent comprises cyclic and/or linear carbonates. In some such embodiments, the non-fluorinated solvent may comprise one or more of carbonate-based solvents selected from the group of dimethyl carbonate, diethyl carbonate, ethyl methyl carbonate, propylene carbonate, and ethylene carbonate. Additionally or alternatively, the at least one non-fluorinated organic solvent may comprise acetates (e.g., methyl acetate, ethyl acetate), alky esters (e.g, ethyl butyrate), lactones (e.g., gamma-butyrolactone), etc.

In some embodiments, the organic solvent may comprise one or more of carbonate-based solvents selected from the group of fluoroethylene carbonate, dimethyl carbonate, diethyl carbonate, ethyl methyl carbonate, propylene carbonate, and ethylene carbonate. In some embodiments, the organic solvent may comprise a mixture of fluoroethylene carbonate and dimethyl carbonate. In some embodiments, a weight ratio of fluoroethylene carbonate and dimethyl carbonate may be greater than or equal to 1:10 and less than or equal to 100:1. In some embodiments, the weight ratio is greater than or equal to 1:4 and less than or equal to 1:3. Other ranges may be possible.

In some embodiments, the electrolyte comprises at least one lithium salt. In one set of embodiments, the lithium salt may comprise one or more of lithium hexafluorophosphate (LiPF₆), lithium bis(fluorosulfonyl)imide (LiFSI), lithium perchlorate (LiClO₄), lithium hexafluoroarsenate (LiAsF₆), lithium tetrafluoroborate (LiBF₄), lithium trifluromethanesulfonate (LiCF₃SO₃), and lithium bis(trifluoromethanesulfonyl)imide (LiTFSI). Additional examples of lithium include, but are not limited to, LiSCN, LiBr, LiI, LiSO₃CH₃, LiNO₃, LiPF₆, LiBF₄, LiB(Ph)₄, LiClO₄, LiAsF₆, Li₂SiF₆, LiSbF₆, LiAlCl₄, lithium bis(oxalato)borate, lithium difluoro(oxalato)borate, a salt comprising a tris(oxalato)phosphate anion (e.g., lithium tris(oxalato)phosphate), LiC(SO₂CF₃)₃, LiCF₃SO₃, LiN(SO₂F)₂, LiN(SO₂CF₃)₂, LiC(CₙF₂ₙ₊₁SO₂)₃ wherein n is an integer in the range of from 1 to 20, and (CₙF₂ₙ₊₁SO₂)mXLi with n being an integer in the range of from 1 to 20, m being 1 when X is selected from oxygen or sulfur, m being 2 when X is selected from nitrogen or phosphorus, and m being 3 when X is selected from carbon or silicon. Other electrolyte salts that may be useful include lithium polysulfides (Li2Sx), and lithium salts of organic polysulfides (LiSxR)n, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃SO₃⁻), bis (fluorosulfonyl)imide (N(FSO₂)₂₋, bis(trifluoromethyl sulfonyl)imide ((CF₃SO₂)₂N⁻, bis (perfluoroethylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis (fluorosulfonyl)imide and 1,2-dimethyl-3-propylimidazolium/bis (trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

In some embodiments, additional layers may be present in the electrochemical devices described elsewhere herein. For example, as shown in FIGS. 5A-5B, one or more intervening layers (e.g., an ion conductive layer) may be positioned between the anode (e.g., anode 120 or 120a) and the separator (e.g., separator 150 or 150a).

In one set of embodiments, the ion conductive layer (e.g., single-ion conductive layer) may have a shape or structure that protects the anode electroactive material layer from one or more undesirable components (within the electrolyte) within the electrochemical cell. In some such embodiments, the anode electroactive material layer may be at least partially encapsulated by the ion conductive layer.

In some embodiments, the ion conductive layer may be formed by any of a variety of appropriate methods and comprise any of a variety of appropriate materials. Some methods relate to forming an ion conductive layer by an aerosol deposition process. Aerosol deposition processes are known in the art and generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of particles. In some aspects, aerosol deposition can be carried out under conditions (e.g., using a velocity) sufficient to cause fusion of at least some of the plurality of particles to at least another portion of the plurality of particles. For example, in some embodiments, a plurality of particles is deposited on an electroactive material (and/or any sublayer(s) disposed thereon) at a relative high velocity such that at least a portion of the plurality of particles fuse (e.g., forming the portion and/or sublayer of the protective layer). The velocity required for particle fusion may depend on factors such as the material composition of the particles, the size of the particles, the Young's elastic modulus of the particles, and/or the yield strength of the particles or material forming the particles.

In some embodiments, an ion conductive layer described herein comprises an inorganic material. The inorganic material(s) may comprise a ceramic material (e.g., a glass, a glassy-ceramic material). The inorganic material(s) may be crystalline, amorphous, or partially crystalline and partially amorphous. In some embodiments, the ion conductive layer comprises LiₓMP_{y}S_{z}. For such inorganic materials, x, y, and z may be integers (e.g., integers less than 32) and/or M may comprise Sn, Ge, and/or Si. By way of example, the inorganic material may comprise Li₂₂SiP₂S₁₈, Li₂₄MP₂S₁₉ (e.g., Li₂₄SiP₂S₁₉), LiMP₂S₁₂ (e.g., where M=Sn, Ge, Si), and/or LiSiPS. Even further examples of suitable inorganic materials include garnets, sulfides, phosphates, perovskites, anti-perovskites, other ion conductive inorganic materials and/or mixtures thereof. When LiₓMP_{y}S_{z} particles are employed in an ion conductive layer thereof, they may be formed, for example, by using raw components Li₂S, SiS₂ and P₂S₅ (or alternatively Li₂S, Si, S and P₂S₅).

In some embodiments, an ion conductive layer described herein comprises an oxide, nitride, and/or oxynitride of lithium, aluminum, silicon, zinc, tin, vanadium, zirconium, magnesium, and/or indium, and/or an alloy thereof. Non-limiting examples of suitable oxides include Li₂O, LiO, LiO₂, LiRO₂ where R is a rare earth metal (e.g., lithium lanthanum oxides), lithium titanium oxides, Al₂O₃, ZrO₂, SiO₂, CeO₂, and Al₂TiO₅. Further examples of suitable materials that may be employed include lithium nitrates (e.g., LiNO₃), lithium silicates, lithium borates (e.g., lithium bis(oxalate)borate, lithium difluoro(oxalate)borate), lithium aluminates, lithium oxalates, lithium phosphates (e.g., LiPO₃, Li₃PO₄), lithium phosphorus oxynitrides, lithium silicosulfides, lithium germanosulfides, lithium fluorides (e.g., LiF, LiBF₄, LiAlF₄, LiPF₆, LiAsF₆, LiSbF₆, Li₂SiF₆, LiSO₃F, LiN(SO₂F)₂, LiN(SO₂CF₃)₂), lithium borosulfides, lithium aluminosulfides, lithium phosphosulfides, oxy-sulfides (e.g., lithium oxy-sulfides), and/or combinations thereof. In some embodiments, the plurality of particles comprises Li—Al—Ti—PO₄ (LATP).

In some embodiments, an ion conductive layer described herein comprises a plurality of particles that are at least partially fused together and/or that have a structure indicative of particles deposited by aerosol deposition comprises an inorganic material. For instance, a plurality of particles that are at least partially fused together and/or that have a structure indicative of particles deposited by aerosol deposition may be formed of an inorganic material. In some embodiments, a plurality of particles that are at least partially fused together and/or that have a structure indicative of particles deposited by aerosol deposition comprise two or more types of inorganic materials. The plurality of particles may comprise any appropriate materials described above.

As described above, in some embodiments, a force, or forces, is applied to portions of an electrochemical cell. Such application of force may reduce irregularity or roughening of an electrode surface of the cell (e.g., when lithium metal or lithium alloy anodes are employed), thereby improving performance. Electrochemical devices in which anisotropic forces are applied and methods for applying such forces are described, for example, in U.S. Pat. No. 9,105,938, issued Aug. 11, 2015, published as U.S. Patent Publication No. 2010/0035128 on Feb. 11, 2010, and entitled “Application of Force in Electrochemical Cells,” which is incorporated herein by reference in its entirety for all purposes.

In the embodiments described herein, batteries may undergo a charge/discharge cycle involving deposition of metal (e.g., lithium metal or other active material) on a surface of an anode upon charging and reaction of the metal on the anode surface, wherein the metal diffuses from the anode surface, upon discharging. The uniformity with which the metal is deposited on the anode may affect cell performance. For example, when lithium metal is removed from and/or redeposited on an anode, it may, in some cases, result in an uneven surface. For example, upon redeposition it may deposit unevenly forming a rough surface. The roughened surface may increase the amount of lithium metal available for undesired chemical reactions which may result in decreased cycling lifetime and/or poor cell performance. The application of force to the electrochemical device has been found, in accordance with some embodiments described herein, to reduce such behavior and to improve the cycling lifetime and/or performance of the cell.

In some embodiments, the battery (e.g., a housing of the battery) is configured to apply, during at least one period of time during charge and/or discharge of the device, an anisotropic force with a component normal to an electrode active surface of one of the electrochemical cells (e.g., first electrochemical cell, second electrochemical cell).

In some embodiments, an anisotropic force with a component normal to an electrode active surface of one of the electrochemical cells (e.g., first electrochemical cell, second electrochemical cell) is applied during at least one period of time during charge and/or discharge of the battery. In some embodiments, the force is applied continuously, over one period of time, or over multiple periods of time that may vary in duration and/or frequency. The anisotropic force may be applied, in some cases, at one or more pre-determined locations, optionally distributed over an active surface of the one or more of the electrochemical cells of the battery. In some embodiments, the anisotropic force is applied uniformly over one or more active surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes some forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an electrode such as an anode, is given its ordinary meaning as would be understood by those of ordinary skill in the art and includes, for example, a force which, at least in part, exerts itself in a direction substantially perpendicular to the surface. Those of ordinary skill can understand other examples of these terms, especially as applied within the description of this document.

In some embodiments, the anisotropic force can be applied such that the magnitude of the force is substantially equal in all directions within a plane defining a cross-section of the battery, but the magnitude of the forces in out-of-plane directions is substantially unequal to the magnitudes of the in-plane forces.

In one set of embodiments, batteries (e.g., housings) described herein are configured to apply, during at least one period of time during charge and/or discharge of the cell, an anisotropic force with a component normal to an electrode active surface of one of the electrochemical cells (e.g., first electrochemical cell, second electrochemical cell). Those of ordinary skill in the art will understand the meaning of this. In such an arrangement, the electrochemical cell may be formed as part of a container which applies such a force by virtue of a “load” applied during or after assembly of the cell, or applied during use of the battery as a result of expansion and/or contraction of one or more components of the battery itself.

The magnitude of the applied force is, in some embodiments, large enough to enhance the performance of the battery. An electrode active surface (e.g., anode active surface) and the anisotropic force may be, in some instances, together selected such that the anisotropic force affects surface morphology of the electrode active surface to inhibit increase in electrode active surface area through charge and discharge and wherein, in the absence of the anisotropic force but under otherwise essentially identical conditions, the electrode active surface area is increased to a greater extent through charge and discharge cycles. “Essentially identical conditions,” in this context, means conditions that are similar or identical other than the application and/or magnitude of the force. For example, otherwise identical conditions may mean a battery that is identical, but where it is not constructed (e.g., by couplings such as brackets or other connections) to apply the anisotropic force on the subject battery.

As described herein, in some embodiments, the surface of an anode can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the anode. For example, for an anode comprising lithium, the cell may be under an externally-applied anisotropic force with a component defining a pressure of at least 10 kg_{f}/cm², at least 20 kg_{f}/cm², or more. This is because the yield stress of lithium is around 7-8 kg_{f}/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling under at least about 10 kg_{f}/cm², at least about 20 kg_{f}/cm², and/or up 30 kg_{f}/cm², up to 40 kg_{f}/cm² of externally-applied pressure, the lithium surface may become smoother with cycling when the pressing surface is smooth.

In some cases, one or more forces applied to the cell have a component that is not normal to an active surface of an anode. In one set of embodiments, the sum of the components of all applied anisotropic forces in a direction normal to any electrode active surface of the battery is larger than any sum of components in a direction that is non-normal to the electrode active surface. In some embodiments, the sum of the components of all applied anisotropic forces in a direction normal to any electrode active surface of the battery is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the electrode active surface.

In some cases, electrochemical cells may be pre-compressed before they are inserted into housings, and, upon being inserted to the house, they may expand to produce a net force on the electrochemical cells. Such an arrangement may be advantageous, for example, if the electrochemical cells are capable of withstanding relatively high variations in pressure.

In some embodiments, the electrodes (e.g., anode structure) described herein can be part of an electrochemical cell (e.g., a rechargeable electrochemical cell). In some embodiments, the electrodes (e.g., anode structure) can be part of an electrochemical cell that is integrated into a battery (e.g., a rechargeable battery).

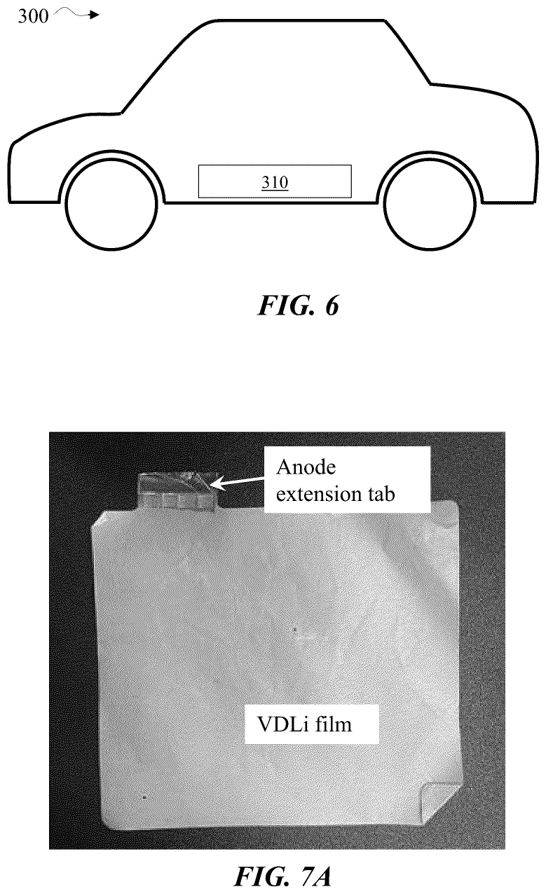

In some embodiments, the article and/or battery described herein containing the electrochemical cell(s) can be used to provide power to an electric vehicle or otherwise be incorporated into an electric vehicle. As a non-limiting example, electrochemical cells and/or articles and/or batteries described in this disclosure can, in some embodiments, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle. FIG. 6 shows a cross-sectional schematic diagram of electric vehicle 300 in the form of an automobile comprising electrochemical device 310, in accordance with some embodiments. Electrochemical device 310 can, in some instances, provide power to a drive train of electric vehicle 300. Electrochemical device 310 may be either an article described herein (e.g., article 100 as shown in FIGS. 1-2) or a battery described herein (e.g., battery 220 as shown in FIG. 6). The article and/or battery may have any of a variety of properties and/or may contain any of a variety of components described elsewhere herein.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240, 113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18, 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. Application No. 14/624/641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848/659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. Pat. No. 10,320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019. patented as U.S. Pat. No. 11,183,690 on Nov. 23, 2021, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, patented as U.S. Pat. No. 11,251,501 on Feb. 15, 2022, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, patented as U.S. U.S. Pat. No. 11,489,348 on Nov. 1, 2022, filed as U.S. application Ser. No. 16/527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, patented as U.S. Pat. No. 11,322,804 on May 3, 2022, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, patented as U.S. Pat. No. 11,424,492 on Aug. 23, 2022, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY″, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”; U.S. Publication No. 2022-0069593 published on Mar. 3, 2022, filed as U.S. application Ser. No. 17/463,467 filed on Aug. 31, 2021, and entitled “Multiplexed Battery Management System”; U.S. Publication No. 2022-0048121 published on Feb. 17, 2022, filed as U.S. application Ser. No. 17/397,114 filed on Aug. 9, 2021, and entitled “Ultrasonic Blade for Cutting a Metal”, U.S. Publication No. 2022-0115715 published on Apr. 14, 2022, filed as U.S. application Ser. No. 17/479,299 filed on Sep. 20, 2021 and entitled “Electrolytes for Reduced Gassing”; U.S. Publication No. 2022-0359902 published on Nov. 10, 2022, filed as U.S. application Ser. No. 17/621,409 filed on Dec. 21, 2021, and entitled “METHODS, SYSTEMS, AND DEVICES FOR APPLYING FORCES TO ELECTROCHEMICAL DEVICES”; U.S. Publication No. 2022-0352521 published on Nov. 3, 2022, filed as U.S. application Ser. No. 17/730,792 on Apr. 27, 2022, and entitled “INTEGRATED BATTERY ELECTRODE AND SEPARATOR”; U.S. Publication No. 2022-0336872 published on Oct. 20, 2022, filed as U.S. application Ser. No. 17/592,406 on Feb. 3, 2022, and entitled “CHARGE/DISCHARGE MANAGEMENT IN ELECTROCHEMICAL CELLS, INCLUDING PARTIAL CYCLE CONTROL”; U.S. Publication No. 2022-0328880 published on Oct. 13, 2022, filed as U.S. application Ser. No. 17/712,754 on Apr. 4, 2022, and entitled “ELECTROLYTES FOR LITHIUM BATTERIES”; U.S. Publication No. 2022-0320586 published on Oct. 6, 2022, filed as U.S. application Ser. No. 17/703,415 on Mar. 24, 2022, and entitled “IN-SITU CONTROL OF SOLID ELECTROLYTE INTERFACE FOR ENHANCED CYCLE PERFORMANCE IN LITHIUM METAL BATTERIES”; U.S. Publication No. 2022-0311081 published on Sep. 29, 2022, filed as U.S. application Ser. No. 17/702,971 on Mar. 24, 2022, and entitled “BATTERY PACK AND RELATED COMPONENTS AND METHODS”; U.S. Publication No. 2022-0271537 published on Aug. 25, 2022, filed as U.S. application Ser. No. 17/592,398 on Feb. 3, 2022, and entitled “CHARGE/DISCHARGE MANAGEMENT IN ELECTROCHEMICAL CELLS, INCLUDING PARTIAL CYCLE CONTROL”; U.S. Publication No. 2022-0209327 published on Jun. 30, 2022, filed as U.S. application Ser. No. 17/565,317 on Dec. 29, 2021, and entitled “TEMPERATURE MANAGEMENT FOR ELECTROCHEMICAL CELLS”; U.S. Publication No. 2022-0199968 published on Jun. 23, 2022, filed as U.S. application Ser. No. 17/552,829 on Dec. 16, 2021, and entitled “LASER CUTTING OF COMPONENTS FOR ELECTROCHEMICAL CELLS”; U.S. Publication No. 2022-0181624 published on Jun. 9, 2022, filed as U.S. application Ser. No. 17/540,611 on Dec. 2, 2021, and entitled “LOW POROSITY ELECTRODES AND RELATED METHODS”; U.S. Publication No. 2022-0181624 published on Jun. 9, 2022, filed as U.S. application Ser. No. 17/492,084 on Oct. 1, 2021, and entitled “ELECTROCHEMICAL CELLS COMPRISING NITROGEN-CONTAINING SPECIES, AND METHODS OF FORMING THEM”.

The following examples are intended to illustrate some embodiments of the present invention, but do not exemplify the full scope of the invention.

### EXAMPLE 1

This example describes a method of forming a double-sided VDLi anode structure comprising metal extension tabs and an electrochemical cell comprising the double-sided VDLi anode structure, according to some embodiments. The double-sided VDLi anode structure had a structure similar to that shown in FIGS. 2A-2B.

A double-sided VDLi anode structure was formed by laminating two single-sided VDLi anode structures together. Each single-sided VDLi anode structure contained the following components arranged in order: a polyethylene terephthalate (PET) layer acting as the release layer, a polyvinyl alcohol (PVOH) layer acting as the insulating layer, a copper current collector with a thickness of 0.2-0.3 μm, and lithium vapor-deposited on top of the copper current collector. A copper foil acting as the anode extension was then welded to the thin layer of copper current collector in the single-sided anode structure to form a weld. The copper foil may advantageously offer a weldable interface to an electrochemical cell tab, as the VDLi layer cannot be welded directly to the tab because of the insulating nature of the PVOH layer beneath the VDLi layer. In addition, the copper tab extension can advantageously connect the anode current collector directly to the cell tab rather than relying partially on the lithium layers. A double-sided VLDi anode structure was then formed by peeling the PET layer off two pieces of single-sided VDLi anode structures and bonding the respective PVOH layers together. FIGS. 7A-7B are photographs showing a top view of the double-sided anode structure comprising anode extension tabs welded to the VDLi films and the underlying copper current collector.

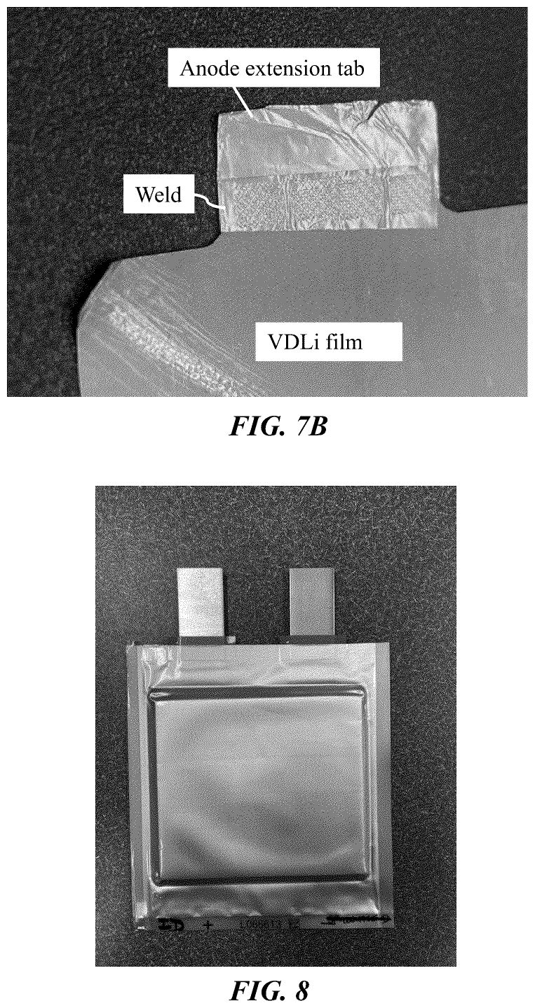

The double-sided anode structures shown in FIGS. 7A-7B, cathodes and separators were next assembled in an alternating fashion into an electrochemical cell, as shown in FIG. 8. The various components may be stacked on top of each in the following order: double-sided VDLi anode structure, separator (containing an electrolyte), cathode (e.g., two cathode electroactive material layers spaced apart by a cathode current collector), separator, etc. The above sequence may be repeated. The copper foil extensions from multiple double-sided VDLi anode structure were then welded to an electrochemical cell tab to establish electrical coupling with the anode terminal.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A);

in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An anode structure, comprising:
a first anode current collector;
a first anode electroactive material layer comprising a lithium film deposited on a first side of the first anode current collector;
a first electrically non-conductive layer positioned adjacent a second side of the first anode current collector opposite the first side;
a first anode extension tab positioned adjacent the first anode electroactive material layer at a side opposite the first anode current collector; and
a first weld formed through a portion of the first anode electroactive material layer between at least a portion of the first anode extension tab and at a least a portion of the first anode current collector.

2. An anode structure, comprising:
an electrically non-conductive layer comprising a first side and a second side;
a first anode current collector positioned adjacent the first side of the electrically non-conductive layer;
a second anode current collector positioned adjacent the second side of the electrically non-conductive layer;
a first anode electroactive material layer comprising a lithium film positioned adjacent the first anode current collector at a side opposite the electrically non-conductive layer;
a second anode electroactive material layer comprising a lithium film positioned adjacent the second anode current collector at a side opposite the electrically non-conductive layer;
a first anode extension tab welded through the first anode electroactive material layer to the first anode current collector; and
a second anode extension tab welded through the second anode electroactive material layer to the second anode current collector.

3. A method, comprising:
in an anode structure comprising:
a first anode current collector; and
a first anode electroactive material layer comprising a lithium film deposited on a first side of the first anode current collector,
performing the steps of:
welding at least a portion of a first anode extension tab to a portion of the anode structure,
such that a first weld protrudes through at least a portion of the first anode electroactive material layer and connects to at least a portion of the first anode current collector.

4. An anode structure as in claim 1, further comprising a second electrically non-conductive layer positioned adjacent the first electrically non-conductive layer at a side opposite the first anode current collector.

5. An anode structure as in claim 4, further comprising a second current collector positioned adjacent the second electrically non-conductive layer at a side opposite first electrically non-conductive layer.

6. An anode structure as in claim 5, further comprising a second anode electroactive material layer comprising a lithium film deposited on the second anode current collector at a side opposite the second electrically non-conductive layer.

7. An anode structure as in claim 6, further comprising a second anode extension tab positioned adjacent the second anode electroactive material layer at a side opposite the second anode current collector.

8. An anode structure as in claim 7, further comprising a second weld formed through a portion of the second anode electroactive material layer between at least a portion of the second anode extension tab and at a least a portion of the second anode current collector.

9-10. (canceled)

11. An anode structure as in claim 1, wherein the lithium film is vapor deposited onto the first anode current collector.

12-20. (canceled)

21. An anode structure as in claim 7, wherein the first and/or second anode extension tab comprises an overhang extending outward from an edge of the first and/or second anode electroactive material layer.

22. An anode structure as in claim 1, wherein the first weld is formed at an edge of the first anode current collector and/or the first anode electroactive material layer.

23-28. (canceled)

29. An anode structure as in claim 7, wherein the first anode electroactive material layer is electrically coupled to the second anode electroactive material layer via the first anode extension tab and/or the second anode extension tab.

30-34. (canceled)

35. An electrochemical cell comprising a plurality of the anode structures as in claim 1.

36. An electrochemical cell as in claim 35, wherein the electrochemical cell comprises an electrolyte positioned adjacent the plurality of anode structures.

37. An electrochemical cell as in claim 35, wherein the electrochemical cell comprises a plurality of cathodes arranged in alternating layers with the plurality of anode structures.

38. (canceled)

39. An electrochemical cell as in claim 35, wherein the plurality of anode structures comprises a plurality of anode extension tabs arranged in a multilayer arrangement.

40. An electrochemical cell as in claim 39, wherein the plurality of anode extension tabs is welded to an electrochemical cell tab.

41. An electrochemical cell as in claim 39, wherein a plurality of anode electroactive material layers of the plurality of anode structures is electrically coupled to each other via the plurality of anode extension tabs.

42. A rechargeable battery comprising the electrochemical cell as in claim 35.

43. An electric vehicle comprising the electrochemical cell as in claim 35.
